(19) United States
(12) Patent Application Publication
(10) Pub. No.: US 2021/0344040 A1
(43) Pub. Date: Nov. 4, 2021

(54) SINTERING LARGE AREA CERAMIC FILMS

(71) Applicant: QUANTUMSCAPE BATTERY, INC., San Jose, CA (US)

(72) Inventors: Niall DONNELLY, Malvern, PA (US); Sriam IYER, Cupertino, CA (US); Jagdeep SINGH, Los Gatos, CA (US); Gengfu XU, Santa Clara, CA (US); Jordan FRIEDLAND, San Jose, CA (US); Hutha SARMA, San Jose, CA (US); Nima SHAH, San Jose, CA (US); Dong Hee Anna CHOI, San Jose, CA (US)

(21) Appl. No.: 17/283,014

(22) PCT Filed: Oct. 16, 2019
(86) PCT No.: PCT/US2019/056584

§ 371 Date: Apr. 5, 2021

Related U.S. Application Data
(60) Provisional application No. 62/746,356, filed on Oct. 16, 2018.

(51) Int. Cl. H01M 10/0562; C04B 35/48; C04B 35/622; C04B 35/634; C04B 35/64; C04B 35/638; H01M 10/0525

(52) U.S. Cl. CPC H01M 10/0562; H01M 2300/0091; C04B 35/62218; C04B 35/6342; C04B 35/63424; C04B 35/64; C04B 35/638; H01M 10/0525; C04B 2235/764; C04B 2235/3248; C04B 2235/3217; C04B 2235/6025; C04B 2235/656; C04B 2235/661; H01M 2300/0077; C04B 35/48

(57) ABSTRACT

Set forth herein are processes and materials for sintering dense thin green films comprising lithium-stuffed garnet powder and a binder to obtain sintered lithium-stuffed garnet thin films. Some of the processes, herein, include providing a first setter and a second setter, wherein the first setter and second setter each include at least 5 atomic % lithium (Li) per setter; placing the green film on the first setter; placing the second setter within 2 cm of the green film but not in contact with the green film; and heating the green film to at least 900 C.

This application claims priority to, and the benefit of, U.S. Provisional Patent Application No. 62/746,356, which was filed Oct. 16, 2018, the entire contents of which are herein incorporated by reference in its entirety for all purposes.

### FIELD

The present disclosure concerns sintering of high density inorganic green films.

### BACKGROUND

Solid-state ceramics, such as lithium-stuffed garnet materials and lithium borohydrides, oxides, sulfides, oxyhalides, and halides have several advantages as materials for ion-conducting electrolyte membranes and separators in a variety of electrochemical devices including fuel cells and rechargeable batteries. When compared to liquid electrolytes, the aforementioned ceramics possess safety and economic advantages as well as advantages related to the material's solid-state and ability to interface with a lithium metal anode. The lithium metal anode allows for correspondingly high volumetric and gravimetric energy densities when these ceramics are incorporated into electrochemical devices as thin film electrolyte separators. Solid-state ion conducting ceramics are well suited for solid-state electrochemical devices because of their high ion conductivity properties in the solid-state, their electric insulating properties, as well as their chemical compatibility with a variety of electrode materials such as lithium metal.

### SUMMARY

The instant disclosure sets forth such materials and processes, in addition to making and using the same, and other solutions to problems in the relevant field.

In one aspect, the instant disclosure provides a process for making a sintered lithium-stuffed garnet thin film, wherein the process includes: (a) providing a green film comprising lithium-stuffed garnet powder and a binder; (b) providing a first setter and a second setter, wherein the first setter and second setter each comprise at least 5 atomic % lithium (Li) per setter; (c) placing the green film on the first setter; (d) placing the second setter within 2 cm of the green film but not in contact with the green film; and (e) heating the green film to at least 900° C.

In a second aspect, the instant disclosure provides a process for making a sintered lithium-stuffed garnet thin film, wherein the process includes: (a) providing a green film comprising lithium-stuffed garnet powder and a binder; (b) providing a first setter; (c) placing the green film on the first setter; (d) exposing the green film to lithium and/or lithium oxide in a vapor phase; and (e) heating the green film to at least 900° C. In some of such embodiments, the method comprises placing a second setter within 2 cm of the green film but not in contact with the green film.

In a third aspect, the instant disclosure provides a process for making a sintered lithium-stuffed garnet thin film, wherein the process includes: (a) providing a green film comprising lithium-stuffed garnet powder and a binder; (b) providing a first setter and a second setter, wherein the first setter and second setter each comprise at least 5 atomic % lithium (Li) per setter; (c) placing the green film between and in contact with the first setter and the second setter; (d) losing contact between the green film and the second setter, wherein the second setter is within 2 cm of the green film but not in contact with the green film; and (e) heating the green film to at least 900° C.

In a fourth aspect, the instant disclosure provides an apparatus comprising a bottom setter; a top setter; and a green film between the bottom setter and the top setter; wherein the green film contacts the bottom setter but does not contact the top setter.

### BRIEF DESCRIPTIONS OF THE DRAWINGS

FIG. 1 shows a comparison of two different sintering processes described herein. In FIG. 1A, the green film 101 is in contact with both the bottom setter plate 103 and the top setter plate 102. In FIG. 1B, the green film 101 is in contact with the bottom setter plate 103 but is not in contact with the top setter plate 102. The gap between the green film 101 and top setter plate 102 is distance 105.

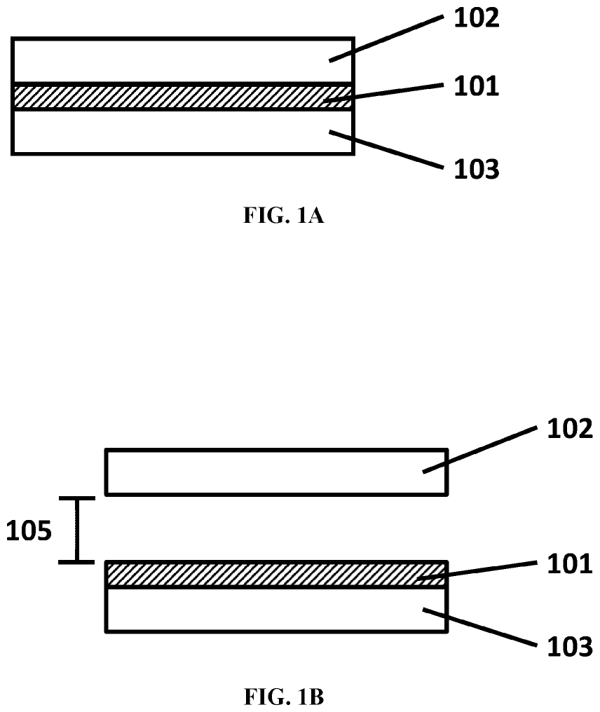

FIGS. 2A and 2B show a sintering experiment and results from the experiment. FIG. 2A shows the results of the experiment, while FIG. 2B shows the positioning of the setter plates during the sintering experiment. In FIG. 2A, the top row shows green films on the bottom setter plates prior to sintering, the lower row shows the sintered films on the bottom plate after sintering. This images show a change in dimensions of the film after sintering. Setter spaces (104) were used to introduce a gap between the setter plates. FIG. 2B shows the gap between the green film and the top setter plate.

FIG. 3 shows the maximum current density (mA/cm²) before failure for a film of lithium-stuffed garnet sintered between and in contact with top and bottom setters (labeled sandwiched) and for a film sintered in contact with a bottom setter and with a gap between the film and the top setter (labeled top setter contactless).

FIG. 4 shows the maximum current density before failure for sintered films of lithium-stuffed garnet prepared by the methods herein. Groups A and B show the results from films sintered between and in contact with a top and bottom setter. Group C shows the results for films sintered on a bottom setter and with a gap between the bottom setter and the top setter.

FIG. 5 shows the effect of area-specific resistance (ASR) of a sintered film of lithium-stuffed garnet as a function of whether the top and bottom setters are in contact with a green film (labeled contact) during sintering or whether there is a gap between the top and bottom setters (labeled contactless) during sintering.

FIG. 6 shows the effect of film flatness of a sintered film of lithium-stuffed garnet as a function of the gap spacing of the top and bottom setters between which a green film is sintered.

FIG. 7 shows the effect of contact sintering (green film is sintered between and in contact with top and bottom setters) vs. contactless sintering (green film is sintered in contact with a bottom setter but not in contact with a top setter) on the fraction of films with pinching or tearing defects.

FIG. 8 shows the average film flatness based on the number of times a set of top and bottom setters are used when the top setter is not in contact with the green film during sintering.

FIG. 9 shows the average film flatness based on the number of times a set of top and bottom setters are used when the top setter is in contact with the green film during sintering.

The figures depict various embodiments of the present disclosure for purposes of illustration only. One skilled in the art will readily recognize from the following discussion that alternative embodiments of the structures and processes illustrated herein may be employed without departing from the principles described herein.

### DETAILED DESCRIPTION

The following description is presented to enable one of ordinary skill in the art to make and use the disclosed subject matter and to incorporate it in the context of applications. Various modifications, as well as a variety of uses in different applications, will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

In the following detailed description, numerous specific details are set forth in order to provide a more thorough understanding of the present disclosure. However, it will be apparent to one skilled in the art that the present disclosure may be practiced without necessarily being limited to these specific details. In other instances, well-known structures and devices are shown in block diagram form, rather than in detail, in order to avoid obscuring the present disclosure.

### A. GENERAL

During thin film sintering processes, setters are used to maintain thin film flatness and also to maintain the appropriate chemical phases in the sintering film when sintering at elevated temperatures. Film-setter interaction during sintering may introduce defects, and thus reducing the contact between sintering thin films and setters during sintering is desirable.

This disclosure sets forth processes for sintering high density green films. The sintered green films are suitable for electrochemical device applications. In an embodiment, the methods and processes described herein involve sintering of a green film between two setter plates wherein only one of the setter plates is in direct contact with the film while the other setter plate is in close proximity to the green film but not in direct contact with the green film.

Elevating the top setter above a thin film, which is on top of a bottom setter, so that the top setter is not in contact with the film, led to improved sintering of the green film. By not contacting the top setter with the green film, it was possible to reduce friction between the sintering green film, during the sintering process, which may hinder lateral film shrinkage and densification. In some cases, this resulted in more uniformly densified sintered films. In some cases, films sintered when there was a gap between the film and the top setter retained the lithium-stuffed garnet phase, retained the appropriate amount of lithium in the lithium-stuffed garnet, retained good microstructure, exhibited less variability in flatness, and showed better dendrite performance. In some cases, the setter plates themselves provided a source of lithium vapor, thereby avoiding the need for placing a lithium source in the vicinity of the green film that was being sintered in order to maintain the lithium-stuffed garnet phase and retain the appropriate amount of lithium in the lithium-stuffed garnet.

### B. DEFINITIONS

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, “providing” refers to the provision of, generation of, presentation of, or delivery of that which is provided. Providing includes making something available. For example, providing a powder refers to the process of making the powder available, or delivering the powder, such that the powder can be used as set forth in a process described herein. As used herein, providing also means measuring, weighing, transferring combining, or formulating.

As used herein, “casting” means to provide, deposit, or deliver a cast solution or slurry onto a substrate. Casting includes, but is not limited to, slot casting, screen printing, gravure coating, dip coating, and doctor blading.

As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm.

As used herein, the phrase “dip casting” or “dip coating” refers to a deposition process whereby a substrate is coated, or deposited, with a solution, liquid, slurry, or the like, by moving the substrate into and out of the solution, liquid, slurry, or the like, often in a vertical fashion.

As used herein, “casting a slurry” refers to a process wherein a slurry is deposited onto, or adhered to, a substrate. Casting can include, but is not limited to, slot casting and dip casting. As used herein, casting also includes depositing, coating, or spreading a cast solution or cast slurry onto a substrate.

As used herein the phrase “casting a film” or “casting a green film” refers to the process of delivering or transferring a liquid or a slurry into a mold, or onto a substrate, such that the liquid or the slurry forms, or is formed into, a green film. Casting may be done via doctor blade, Meyer rod, comma coater, gravure coater, microgravure, reverse comma coater, slot dye, slip and/or tape casting, and other processes. In some embodiments, the cast green film is calendered prior to sintering.

As used herein, “flatness” of a surface refers to the greatest normal distance between the lowest point on a surface and a plane containing the three highest points on the surface, or alternately, the greatest normal distance between the highest point on a surface and a plane containing the three lowest points on the surface. It may be measured with an AFM, a high precision optical microscope, or laser interferometry height mapping of a surface. Unless specified to the contrary, flatness is measured by laser interferometry height mapping instrument such as a Keyence Microscope with a laser measuring device.

As used herein, the term “laminating” refers to the process of sequentially depositing green film layers. As used herein, the term “laminating” also refers to the process whereby a layer comprising an electrode, e.g., positive electrode or cathode active material comprising layer, is contacted to a layer comprising another material, e.g., garnet electrolyte. The laminating process may include a reaction or use of a binder which adheres or physically maintains the contact between the layers which are laminated. Laminating also refers to the process of bringing together unsintered, green ceramic films, potentially while under pressure and/or heating to join the films.

As used herein, the phrase “green film” refers to an unsintered film that includes lithium-stuffed garnet or precursors to lithium-stuffed garnet and at least one of a binder, plasticizer, carbon, dispersant, solvent or combinations thereof. A green film is not necessarily green in color. Green refers to the unsintered nature of the film.

As used herein, “green film tape” refers to a roll, continuous layer, or cut portion thereof of casted tape, either dry or not dry, of green film.

As used herein, the phrase “non-reactive environment” is either an environment which is at an ambient atmosphere at temperature less than 30° C. and with a dew point below −40° C. or a non-reactive environment is an environment which is supplied with argon gas at temperature less than 30° C. and with a dew point below −40° C. Examples include a dry room, such as the commercial dry room sold by Scientific Climate Systems. Other examples include a glove box, sold as that sold by MBraun.

As used herein, the phrase “thickness” or “film thickness” or “green film thickness” refers to the distance, or median measured distance between the top and bottom faces of a green film. As used herein, the top and bottom faces refer to the sides of the green film having the largest surface area.

As used herein, “thin” means, when qualifying a green film refers to a thickness dimension less than 200 μm, sometimes less than 100 μm and in some cases between 0.1 μm and 60 μm. Thin means at least 10 nm or greater than 10 nm, but less than 200 μm.

As used herein, the phrases “garnet precursor chemicals,” “chemical precursor to a garnet-type electrolyte,” or “garnet chemical precursors” refer to chemicals which react to form a lithium-stuffed garnet. These chemical precursors include, but are not limited to, lithium hydroxide (e.g., LiOH), lithium oxide (e.g., Li₂O), lithium carbonate (e.g., Li₂CO₃), zirconium oxide (e.g., ZrO₂), lanthanum oxide (e.g., La₂O₃), aluminum oxide (e.g., Al₂O₃), aluminum (e.g., Al), aluminum nitrate (e.g., AlNO₃), aluminum nitrate nonahydrate, corundum, aluminum (oxy) hydroxide (gibbsite and boehmite), gallium oxide, niobium oxide (e.g., Nb₂O₅), and tantalum oxide (e.g., Ta₂O₅).

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃). Molar ratios are as batched unless indicated expressly to the contrary.

As used herein, the phrase “as batched,” refers to the respective molar amounts of components as initially mixed or provided at the beginning of a synthesis. For example, the formula Li₇La₃Zr₂O₁₂, as batched, means that the molar ratio of Li to La to Zr to O in the reagents used to make Li₇La₃Zr₂O₁₂ was 7 to 3 to 2 to 12.

As used herein, the phrase “characterized by the formula,” refers to a molar ratio of constituent atoms either as batched during the process for making that characterized material or as empirically determined. Unless specified to the contrary, “characterized by the formula,” refers to a molar ratio of constituent atoms as batched during the process for making that characterized material.

As used herein the term “solvent,” refers to a liquid that is suitable for dissolving, suspending or solvating a component or material described herein. For example, a solvent includes a liquid, e.g., toluene, which is suitable for dissolving a component, e.g., the binder, used in the garnet sintering process. Unless specified otherwise, a solvent refers to a solvent that is chemically compatible with lithium-stuffed garnet. Chemically compatible with lithium-stuffed garnet means that the solvent does not react with lithium-stuffed garnet during the time when the solvent and the lithium-stuffed garnet are in contact with each other, in a way that can be measured using x-ray diffraction or scanning electron microscopy.

As used herein, the term “anhydrous” refers to a substance containing less than 20 ppm water.

As used herein, the term “aprotic solvent” refers to a liquid comprising solvent molecules that do not include a labile or dissociable proton, hydronium, or hydroxyl species. An aprotic solvent molecule does not include a hydroxyl group or an amine group.

As used herein the phrase “removing a solvent,” refers to the process whereby a solvent is extracted or separated from the components or materials set forth herein. Removing a solvent includes, but is not limited to, evaporating a solvent. Removing a solvent includes, but is not limited to, using elevated temperature, a vacuum or a reduced pressure to drive off a solvent from a mixture, e.g., an unsintered green film. In some examples, a film that includes a binder and a solvent is heated or also optionally placed in a vacuum or reduced atmosphere environment to evaporate the solvent to leave the binder, which was solvated, in the thin film after the solvent is removed.

As used herein, a “binder” refers to a material that assists in the adhesion of another material. For example, as used herein, polyvinyl butyral is a binder because it is useful for adhering garnet materials. Other binders may include polycarbonates. Other binders may include polyacrylates and polymethacrylates. These examples of binders are not limiting as to the entire scope of binders contemplated here but merely serve as examples. Binders useful in the present disclosure include, but are not limited to, polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly(methylene cyclopentane) (PE-co-PMCP), poly(methyl methacrylate) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, and the like.

As used here, the phrase “lithium-stuffed garnet electrolyte,” refers to oxides that are characterized by a crystal structure related to a garnet crystal structure. Lithium-stuffed garnets include compounds having the formula Li_{A}La_{B}M′_{c}M″_{D}Zr_{E}O_{F}, Li_{A}La_{B}M′_{C}M″_{D}Ta_{E}O_{F}, or Li_{A}La_{B}M′_{c}M″_{D}Nb_{E}O_{F}, wherein 4<A<8.5, 1.5<B<4, 0≤C≤2, 0≤D≤2; 0≤E≤2, 10<F<13, and M′ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d≤2; 0≤e≤2, 10<f<13 and Me″ is a metal selected from Nb, Ta, V, W, Mo, Ga, or Sb and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples, x is 6-7 and y is 1.0. In some examples, x is 7 and y is 0.35. In some examples, x is 6-7 and y is 0.7. In some examples, x is 6-7 and y is 0.4. Also, garnets as used herein include, but are not limited to, LiₓLa₃Zr₂O₁₂+yAl₂O₃, wherein x is from 5 to 8 and y is from 0 to 1. Non-limiting example lithium-stuffed garnet electrolytes are found, for example, in US Patent Application Publication No. 2015-0200420 A1, which published Jul. 16, 2015; also in U.S. Pat. Nos. 9,806,372 B2; 9,966,630 B2; 9,970,711 B2; and 10,008,742 B2.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein the phrase “garnet-type electrolyte,” refers to an electrolyte that includes a lithium-stuffed garnet material described herein as the solid separator or ionic conductor. The advantages of lithium-stuffed, garnet solid-state electrolytes are many, including as a substitution for liquid, flammable electrolytes commonly used in lithium rechargeable batteries.

As used herein, the phrase “d₅₀ diameter” refers to the median size, in a distribution of sizes, measured by microscopy techniques or other particle size analysis techniques, such as, but not limited to, scanning electron microscopy or dynamic light scattering. D₅₀ includes the characteristic dimension at which 50% of the particles are smaller than the recited size. D₅₀ herein is calculated on a volume basis, not on a number basis.

As used herein, the phrase “d₉₀ diameter” refers to the 90^{th} percentile size, in a distribution of sizes, measured by microscopy techniques or other particle size analysis techniques, such as, but not limited to, scanning electron microscopy or dynamic light scattering. D₉₀ includes the characteristic dimension at which 90% of the particles are smaller than the recited size. D₉₀ here is calculated on a volume basis, not on a number basis.

As used herein, a particle size distribution “PSD” is measured by light scattering, for example, using on a Horiba LA-950 V2 particle size analyzer in which the solvents used for the analysis include toluene, IPA, or acetonitrile and the analysis includes a one-minute sonication before measurement.

As used herein, the term “calcining” refers to processes involving chemical decomposition reactions or chemical reactions between solids (see Ceramic Processing and Sintering, Second Edition, M. N. Rahaman, 2005). Calcining is a different process from sintering, as used herein. Sintering involves densification and does not strive to achieve a desired phase for the material but, rather, a stable mechanical body. Sintering requires a high starting density and is typically done at higher temperatures, so-called firing temperatures. Calcining involves chemical decomposition reactions or chemical reactions between solids and not a reduction in surface free energy of consolidated particles.

As used herein the phrase “sintering the green film,” “sintering,” or “sintering the film,” refers to a process whereby a thin green film, as described herein, is densified (made denser, or made with a reduced porosity) through the use of heat sintering or field assisted sintering. Sintering includes the process of forming a solid mass of material by heat and/or pressure without melting it to the point of complete liquification. Sintering produces a reduction in surface free energy of consolidated particles, which can be accomplished by an atomic diffusion process that leads to densification of the body, by transporting matter from inside grains into pores or by coarsening of the microstructure, or by rearrangement of matter between different parts of pore surfaces without actually leading to a decrease in pore volumes.

As used herein, the term “plasticizer” refers to an additive that imparts either flexibility or plasticity to the green film. It may be a substance or material used to increase the binder's flexibility, workability, or distensibility. Flexibility is the ability to bend without breaking. Plasticity is the ability to permanently deform.

As used herein, the phrase “stress relieving,” refers to a process which eliminates residual stress in a casted green film during drying and associated shrinkage. One process of stress relieving includes heating the green film at a temperature above the glass transition temperature of the organic components in the green film to allow structural and stress rearrangement in the casted green film to eliminate residual stress. Another process of stress relieving includes heating a casted green film to 70° C. and holding at that temperature for a minute to allow casted green film to relieve stress.

As used herein, a “geometric density” is calculated by dividing the mass of the green film or the sintered green film by its volume. The volume of the green film or the sintered green film is obtained from thickness and diameter measurements of the tape. A micrometer is used to measure thickness, while the diameter is obtained using optical microscopy. Density herein is geometric density unless expressly stated otherwise or to the contrary.

As used herein, a “pycnometry density” is measured using a Micromeritics AccuPycII 1340 Calibrate instrument. Using this instrument, a controlled amount of a powder sample is placed in a cup and its mass measured. The instrument is used to measure volume and calculate density by mass/volume.

As used herein, a green film is considered to have high density if its density is above 2 g/cm³ as measured by geometric density.

As used herein, the phrase “sintering aid,” refers to an additive that is used to either lower the melting point of a liquid phase or that allows for faster sintering than otherwise would be possible without the sintering add. Sintering aids assist in the diffusion/kinetics of atoms being sintered. For example, Li₃BO₃ may be used as an additive in sintering to provide for faster or more complete densification of garnet during sintering.

As used herein, the phrase “source powder” refers to an inorganic material used in a slurry set forth herein. In some examples, the source powder is a lithium-stuffed garnet. For example, the source powder may include a powder of Li₇La₃Zr₂O₁₂.0.5Al₂O₃.

As used herein, the term “DBP” refers to the chemical having the formula C₁₆H₂₂O₄, dibutyl phthalate, having a molecular weight of 278.35 g/mol.

As used herein, the term “BBP,” refers to benzyl butyl phthalate, C₁₉H₂₀O₄, and having a molecular weight of 312.37 g/mol.

As used herein, the term “PEG,” refers to polyethylene glycol. Unless otherwise specified, the molecular weight of the PEG is from 400 to 6000 g/mol.

### C. SETTER PLATES

In some examples, the green films prepared by the processes herein, and those incorporated by reference, are sintered between setter plates. In some examples, the green films prepared by the processes herein, and those incorporated by reference, are sintered on at least one setter plate. In some examples, these setter plates are composed of a metal, an oxide, a nitride, or a metal, oxide, or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr) setter plates, zirconia setter plates, porous zirconia setter plates, lithium oxide setter plates, porous lithium oxide setter plates, lanthanum oxide setter plates, porous lanthanum oxide setter plates, lithium-stuffed garnet setter plates, porous garnet setter plates, lithium-stuffed garnet setter plates, porous lithium-stuffed garnet setter plates, and combinations thereof. In some examples, the setter plates are lithium-stuffed garnet setter plates or porous lithium-stuffed garnet setter plates. In some examples, the setter plates include an oxide material with lithium concentration greater than 5 mmol/cm³.

In some examples, including any of the foregoing, the setter plates and the sintering processes set forth in U.S. Patent No. US20170062873A1, entitled LITHIUM-STUFFED GARNET SETTER PLATES FOR SOLID ELECTROLYTE FABRICATION, and PCT Patent Application No. WO2016168723A1, entitled SETTER PLATES FOR SOLID ELECTROLYTE FABRICATION AND PROCESSES OF USING THE SAME TO PREPARE DENSE SOLID ELECTROLYTES, and US20170047611A1, each of which is incorporated herein by reference in their entirety for all purposes.

In some examples, including any of the foregoing, a setter plate may comprise an oxide, such as lithium-stuffed garnet, and Li₂ZrO₃, Li₂SiO₃, LiLaO₂, LiAlO₂, Li₂O, or Li₃PO₄. In some examples, a setter plate comprises lithium-stuffed garnet and one or more of Li₂ZrO₃, Li₂SiO₃, LiLaO₂, LiAlO₂, Li₂O, or Li₃PO₄. In some examples, a setter plate comprises lithium-stuffed garnet, wherein the garnet is represented by the formula Li_{A}La_{B}M′_{c}M″_{D}Zr_{E}O_{F}, wherein 4<A<8.5, 1.5<B<4, 0≤C≤2, 0≤D≤2; 0≤E≤2, 10<F<13, and M′ and M″ are each, independently in each instance selected from Al, Mo, W, Nb, Sb, Ca, Ba, Sr, Ce, Hf, Rb, or Ta, and one or more of Li₂ZrO₃, Li₂SiO₃, LiLaO₂, LiAlO₂, Li₂O, or Li₃PO₄.

In some examples, including any of the foregoing, combinations of setter plates that may be used, for example, in combination with a lithium-stuffed garnet setter plates described herein. These setter plates include setter plates having a high melting point, a high lithium activity, and a stability in reducing environment. A high lithium activity means that the setter plate includes a sufficient amount of lithium to volatize lithium, or provide lithium vapor around the setter, when the setter is heated to temperature of 500° C. greater. Some examples of these other materials include a member selected from Li₂ZrO₃, xLi₂O-(1-x)SiO₂ (where x=0.01-0.99), aLi₂O-bB₂O₃-cSiO₂ (where a+b+c=1), LiLaO₂, LiAlO₂, Li₂O, Li₃PO4, a lithium-stuffed garnet, or combinations thereof. Additionally, these other setter plates should not induce a chemical potential in the sintering film which results in Li diffusion out of the sintering film and into the setter plate. Additional materials include lanthanum aluminum oxide, pyrochlore and materials having a lithium concentration of greater than 0.01 mol/cm³. In some examples, setter plates may include materials having a lithium concentration of greater than 0.02 mol/cm³. In some examples, setter plates may include materials having a lithium concentration of greater than 0.03 mol/cm³. In some examples, setter plates may include materials having a lithium concentration of greater than 0.04 mol/cm³. In some examples, setter plates may include materials having a lithium concentration of greater than 5 mmol/cm³. In some examples, setter plates may include materials having a lithium concentration of between 10-15 mmol/cm³. In some examples, the setter material may be provided as a powder or in a non-planar shape. In some examples, the setters may include a combination of any material described herein, so long as it meets the requirements for having a high melting point, a high lithium activity, and a stability in reducing environment. A high melting point means a melting, or decomposition, point above 1000° C. In some examples, the setter surface has a higher lithium concentration than the interior. In some examples, the setter surface has a lower lithium concentration than the interior.

In some examples, including any of the foregoing, the anhydrous, aprotic solvent for use with the slurries described herein includes one or more solvents selected from toluene, xylene, ethyl acetate, tetrahydrofuran, dioxane, and 1,2-dimethoxyethane, or combinations thereof—optionally with one or more dispersants, optionally with one or more binders, and optionally with one or more plasticizers. In some examples, the solvent includes about 0-35% w/w anhydrous toluene. In some examples, the solvent includes about 0-35% xylene. In some examples, the solvent includes about 0-35% dioxane. In some examples, the solvent includes 0-35% w/w tetrahydrofuran. In some examples, the solvent includes about 0-35% w/w 1,2-dimethoxyethane. In some examples, the dispersant is 0-5% w/w. In some examples, the binder is about 0-10% w/w. In some examples, the plasticizer is 0-10% w/w. In these examples, the garnet or calcined precursor materials represent the remaining % w/w (e.g., 40%, 50%, 60%, 70%, or 75% w/w).

In some examples, including any of the foregoing, a dispersant is used during the milling process. Examples of dispersants, include, but are not limited to, a dispersant selected from the group consisting of fish oil, fatty acids of degree C₈-C₂₀ (for example, dodecanoic acid, oleic acid, stearic acid, linolenic acid, linoleic acid), alcohols of degree C₈-C₂₀ (for example, dodecanol, oleyl alcohol, stearyl alcohol), alkylamines of degree C₈-C₂₀ (for example, dodecylamine, oleylamine, stearylamine), phosphate esters, phospholipids (for example, phosphatidylcholine, lecithin) polymeric dispersants such as poly(vinylpyridine), poly(ethylene imine), poly(ethylene oxide) and ethers thereof, poly(ethylene glycol) and ethers thereof, polyalkylene amine, polyacrylates, polymethacrylates, poly(vinyl alcohol), poly(vinyl acetate), polyvinyl butyral, maleic anhydride copolymers, glycolic acid ethoxylate lauryl ether, glycolic acid ethoxylate oleyl ether, sodium dodecyl sulfate, sodium dodecylbenzenesulfonate, cetyltrimethylammonium bromide, cetylpyridinium chloride, surfactants and dispersants from the Brij family of surfactants, the Triton family of surfactants, and the Solsperse family of dispersants, the SMA family of dispersants, the Tween family of surfactants, and the Span family of surfactants. Dispersants may be combined.

In some examples, including any of the foregoing, the binders suitable for use with the slurries described herein include binders used to facilitate the adhesion between the lithium-stuffed garnet particles, and include, but are not limited to, polypropylene (PP), atactic polypropylene (aPP), isotactic polypropylene (iPP), other polyolefins such as ethylene propylene rubber (EPR), ethylene pentene copolymer (EPC), polyisobutylene (PIB), styrene butadiene rubber (SBR), poly(ethylene-co-1-octene) (PE-co-PO), poly(ethylene-co-methylene cyclopentene) (PE-co-PMCP), stereoblock polypropylenes, polypropylene polymethyl pentene, polyethylene oxide (PEO), PEO block copolymers, silicone polymers and copolymers, polyvinyl butyral (PVB), poly(vinyl acetate) (PVAc), polyvinylpyrrolidine (PVP), poly(ethyl methacrylate) (PEMA), acrylic polymers (for example polyacrylates, polymethacrylates, and copolymers thereof), binders from the Paraloid family of resins, binders from the Butvar family of resins, binders from the Mowital family of resins. Binders may be combined.

In some examples, including any of the foregoing, the slurry may also include a plasticizer. A non-limiting list of plasticizers includes dibutyl phthalate, dioctyl phthalate, and benzyl butyl phthalate. Plasticizers may be combined.

In some examples, including any of the foregoing, the setter porosity is at least 1% by volume. In some examples, the setter porosity is at least 3% by volume. In some examples, the setter porosity is at least 5% by volume. In some examples, the setter porosity is at least 10% by volume. In some examples, the setter porosity is at least 15% by volume. In some examples, the setter porosity is at least 20% by volume. In some examples, the setter porosity is at least 25% by volume. In some examples, the setter porosity is at least 30% by volume. In some examples, the setter porosity is at least 35% by volume. In some examples, the setter porosity is at least 40% by volume. In some examples, the setter porosity is at least 45% by volume. In some examples, the setter porosity is at least 50% by volume. In some examples, the setter porosity is at least 55% by volume. In some examples, the setter porosity is at least 60% by volume. In some examples, the setter has a porosity that varies throughout the thickness of the setter. In some examples, the setter surfaces are more porous than the interior. In some examples, the setter surfaces are less porous than the interior.

In some examples, including any of the foregoing, the setter has a porosity of between 1% by volume to 10% by volume, between 1% by volume to 8% by volume, or between 1% by volume to 5% by volume. In some examples, the setter has a maximum porosity percentage of 60% by volume, 70% by volume, 80% by volume, or 90% by volume.

In some examples, including any of the foregoing, the setter has one surface layer comprising a metal. In some examples, the setter has two surfaces with a layer comprising a metal.

In some examples, including any of the foregoing, 5 atomic % lithium characterizes the total amount of lithium present in the first setter. In some embodiments, 5 atomic % lithium characterizes the total amount of lithium present in the second setter. In some embodiments, 5 atomic % lithium characterizes the total amount of lithium present in the first setter or the second setter. In some embodiments, the 5 atomic % lithium characterizes the total amount of lithium which is ionically or covalently bonded to the material or materials constituting the first setter or the second setter.

In some examples, including any of the foregoing, the first setter or the second setter comprise, or both the first setter and the second setter comprise, at least 5 atomic % Li per setter. In some instances, the first setter or the second setter comprise, or both the first setter and the second setter comprise, at least 10 atomic % Li per setter. In some instances, the first setter or the second setter comprise, or both the first setter and the second setter comprise, at least 15 atomic % Li per setter. In some instances, the first setter or the second setter comprise, or both the first setter and the second setter comprise, at least 20 atomic % Li per setter. In some instances, the first setter or the second setter comprise, or both the first setter and the second setter comprise, at least 25 atomic % Li per setter. In some instances, the first setter or the second setter comprise, or both the first setter and the second setter comprise, at least 30 atomic % Li per setter. In some instances, the first setter or the second setter comprise, or both the first setter and the second setter comprise, at least 35 atomic % Li per setter. In some instances, the first setter or the second setter comprise, or both the first setter and the second setter comprise, at least 40 atomic % Li per setter. In some instances, the first setter or the second setter comprise, or both the first setter and the second setter comprise, 10 atomic % to 40 atomic % Li per setter, 15 atomic % to 35 atomic % per setter, or 20 atomic % to 30 atomic % per setter.

In some examples, including any of the foregoing, the first setter comprises 100% w/w lithium-stuffed garnet having the empirical formula Li₇La₃Zr₂O₁₂-xAl₂O₃, wherein x is a rational number and 0≤x≤1. In some of such embodiments, when x is 0, the atomic % lithium is 100*( 7/24)%.

In some examples, including any of the foregoing, the slurry comprises a solvent. In some examples, the solvent is selected from the group consisting of toluene, xylene, ethyl acetate, tetrahydrofuran, dioxane, and 1,2-dimethoxyethane.

In some examples, including any of the foregoing, for any of the preceding embodiments, the binder is a polymer is selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), PVB, polyethylene oxide poly(allyl glycidyl ether) PEO-AGE, polyethylene oxide 2-methoxyethoxyethyl glycidyl ether (PEO-MEEGE), polyethylene oxide 2-methoxyethoxyethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), and polyethylene.

In some examples, including any of the foregoing, the 5 atomic % lithium characterizes the total amount of lithium present in the first setter or the second setter. In some instances, the 5 atomic % lithium characterizes the total amount of lithium which is ionically or covalently bonded to the material or materials constituting the first setter or the second setter.

In some examples, including any of the foregoing, the first setter comprises 100% w/w lithium-stuffed garnet having the empirical formula Li₇La₃Zr₂O₁₂-xAl₂O₃, wherein x is a rational number and 0≤x≤1. In some cases, the first setter comprises 1% w/w lithium-stuffed garnet having the empirical formula Li₇La₃Zr₂O₁₂-xAl₂O₃, wherein x is a rational number and 0≤x≤1. In some of such instances, when x is 0, the atomic % lithium is 100*( 7/24)%.

### D. SETTER DIMENSIONS

In some examples, including any of the foregoing, the thickness of the setter is at least about 10 μm, 50 μm, 100 μm, 200 μm, 300 μm, 400 μm, or 500 μm. In some embodiments, the thickness of the setter is about 10 μm-500 μm, 10 μm-400 μm, 10 μm-200 μm, or 25 μm-100 μm. In some embodiments, the setter is about 10 μm-200 μm thick.

In some examples, including any of the foregoing, the thickness of a setter is at least about 10 μm, 50 μm, 100 μm, 200 μm, 300 μm, 400 μm, or 500 μm. In some embodiments, the thickness of a setter is about 10 μm-500 μm, 10 μm-400 μm, 10 μm-200 μm, or 25 μm-100 μm. In some embodiments, the setter is about 10 μm-200 μm thick.

In some examples, including any of the foregoing, the first setter or the second setter has, or both the first and the second setter have, a surface roughness from 1.0 μm Rₐ to 4 μm Rₐ, wherein Rₐ is an arithmetic average of absolute values of sampled surface roughness amplitudes. In some examples, the first setter or the second setter has, or both the first and the second setter have, a surface roughness from 0.5 μm Rₜ to 30 μm Rₜ, wherein Rₜ is the maximum peak height of sampled surface roughness amplitudes. In some instances, the first setter or the second setter has, or both the first and the second setter have, a surface roughness from 1.6 μm Rₐ to 2.2 μm Rₐ. In some instances, the first setter or the second setter has, or both the first and the second setter have, a surface roughness 3.2 μm Rₐ to 3.7 μm Rₐ. In some instances, the first setter or the second setter has, or both the first and the second setter have, a surface roughness 1 μm Rₜ to 28 μm Rₜ. In some instances, the first setter or the second setter has, or both the first and the second setter have, a surface roughness 10 μm Rₜ to 30 μm Rₜ. In some instances, the first setter or the second setter has, or both the first and the second setter have, a surface roughness 15 μm Rₜ to 30 μm Rₜ. Surface roughness is measured by laser microscope measuring techniques, for example using a Keyence Microscope with a laser measuring device.

In some examples, including any of the foregoing, a setter has a surface defined by a first lateral dimension from 1 cm to 50 cm and a second lateral dimension from 0.001 cm to 50 cm. In some instances, a setter has a surface defined by a first lateral dimension from 1 cm to 20 cm and a second lateral dimension from 1 cm to 20 cm. In some instances, a setter has a surface defined by a first lateral dimension from 3 cm to 5 cm and a second lateral dimension from 3 cm to 5 cm. In some instances, a setter has a surface defined by a first lateral dimension from 5 cm to 8 cm and a second lateral dimension from 5 cm to 8 cm. In some instances, a setter has a surface defined by a first lateral dimension from 8 cm to 11 cm and a second lateral dimension from 8 cm to 11 cm. In some instances, a setter has a surface defined by a first lateral dimension from 8 cm to 11 cm and a second lateral dimension from 11 cm to 15 cm. In some instances, a setter has a surface defined by a first lateral dimension from 8 cm to 11 cm and a second lateral dimension from 11 cm to 13 cm.

In some examples, including any of the foregoing, the geometric surface area of a setter is from about 9 cm² to about 225 cm².

In some examples, including any of the foregoing, the first setter has a surface defined by a first lateral dimension from 1 cm to 100 cm and a second lateral dimension from 0.001 cm to 100 cm. In some instances, for any of the preceding embodiments, the second setter has a surface defined by a first lateral dimension from 1 cm to 100 cm and a second lateral dimension from 0.001 cm to 100 cm. In some examples, the first setter has a surface defined by a first lateral dimension from 2 cm to 50 cm and a second lateral dimension from 2 cm to 50 cm. In some examples, the second setter has a surface defined by a first lateral dimension from 2 cm to 50 cm and a second lateral dimension from 2 cm to 50 cm. In some examples, the first setter or second setter has, or both the first and second setter have, a thickness from 0.1 mm to 100 mm.

In some examples, including any of the foregoing, the process maintains the flatness of the green film. In some instances, for any of the preceding embodiments, the process produces a sintered lithium-stuffed garnet solid electrolyte less than 100 microns thick and more than 1 nm thick. In some instances, for any of the preceding embodiments, the process produces a sintered lithium-stuffed garnet solid electrolyte that has a bulk ASR from between 0.1 Ω·cm² to 10 Ω·cm² at 50° C. In some of such instances, the lithium-stuffed garnet solid electrolyte product is a free standing garnet thin film, i.e., after sintering, the sintered film can be removed from the setter plate and is suitable for post-sintering handling and manipulation.

In some examples, including any of the foregoing, each setter has a first and a second dimension that is about 10%-50% larger than the first and second dimension of the green film.

### E. THIN FILMS OF LITHIUM-STUFFED GARNET

In some examples, the lithium-stuffed garnet powder in the green film is a calcined lithium-stuffed garnet powder. In some of such instances, the lithium-stuffed garnet powder in the green film is selected from lithium-stuffed garnet oxide characterized by the formula LiᵤLaᵥZrₓO_{y}.zAl₂O₃, wherein

u is a rational number from 4 to 8;

v is a rational number from 2 to 4;

x is a rational number from 1 to 3;

y is a rational number from 10 to 14; and

z is a rational number from 0.05 to 1;

wherein u, v, x, y, and z are selected so that the lithium-stuffed garnet oxide is charge neutral.

In some examples, including any of the foregoing, the lithium-stuffed garnet powder in the green film is selected from LiₓLa_{y}Zr_{z}Oₜ.qAl₂O₃, wherein 4<x<10, 1<y<4, 1<z<3, 6<t<14, and 0≤q≤1. In some instances, the lithium-stuffed garnet powder in the green film is selected from Li₇La₃Zr₂O₁₂.Al₂O₃ and Li₇La₃Zr₂O₁₂.0.35Al₂O₃. In some instances, the lithium-stuffed garnet powder in the green film is doped with Nb, Ga, and/or Ta.

In some examples, including any of the foregoing, the lithium-stuffed garnet powder in the green film is a calcined lithium-stuffed garnet powder.

In some examples, including any of the foregoing, the lithium-stuffed garnet powder in the green film is selected from lithium-stuffed garnet oxide characterized by the formula LiᵤLaᵥZrₓO_{y}.zAl₂O₃, wherein

u is a rational number from 4 to 8;

v is a rational number from 2 to 4;

x is a rational number from 1 to 3;

y is a rational number from 10 to 14; and

z is a rational number from 0.05 to 1;

wherein u, v, x, y, and z are selected so that the lithium-stuffed garnet oxide is charge neutral.

In some examples, including any of the foregoing, the lithium-stuffed garnet powder in the green film is selected from LiₓLa_{y}Zr_{z}Oₜ.qAl₂O₃, wherein 4<x<10, 1<y<4, 1<z<3, 6<t<14, and 0≤q≤1. In some examples, the lithium-stuffed garnet powder in the green film is selected from Li₇La₃Zr₂O₁₂.Al₂O₃ and Li₇Li₃Zr₂O₁₂.0.35Al₂O₃. In some examples, the lithium-stuffed garnet powder in the green film is doped with Nb, Ga, and/or Ta.

In some examples, including any of the foregoing, the slurry comprises a solvent. In some of such examples, the solvent is selected from the group consisting of toluene, xylene, ethyl acetate, tetrahydrofuran, dioxane, and 1,2-dimethoxyethane.

In some examples, including any of the foregoing, the binder is a polymer is selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), and polyethylene.

In some examples, including any of the foregoing, the sintered film has a surface area that is 50% less than the surface area of the green film. In some instances, for any of the preceding embodiments, the sintered film has a surface area that is 40% less than the surface area of the green film. In some instances, for any of the preceding embodiments, the sintered film has a surface area that is 30% less than the surface area of the green film. In some instances, for any of the preceding embodiments, the sintered film has a surface area that is 20% less than the surface area of the green film. In some instances, for any of the preceding embodiments, the sintered film has a surface area that is 10% less than the surface area of the green film.

In some examples, including any of the foregoing, the green film has a density of greater than, or equal to, 2 g/cm³ as measured by geometric density. In some instances, the lithium and/or lithium oxide in a vapor phase is provided by the first setter, or by a second setter that is placed within 2 cm of the green film but not in contact with the green film, or by both. In some instances, the second setter is placed substantially parallel to the first setter. In some instances, the second setter is placed substantially parallel to the first setter. In some examples, the first setter or the second setter, or both, comprise at least 5 atomic % lithium (Li) per setter. In some instances, prior to providing a green film comprising lithium-stuffed garnet powder and a binder, the process comprises providing a slurry comprising lithium-stuffed garnet powder and a binder. In certain cases, the steps of placing the second setter within 2 cm of the green film but not in contact with the green film; and heating the green film to at least 900° C., occur concurrently. In some instances, the process comprises placing a second setter within 2 cm of the green film but not in contact with the green film.

During sintering, a lithium-stuffed garnet green film may be in contact with a lithium source, wherein the lithium source can be a bottom setter, a top setter, a lithium source near the film, or a vapor phase, wherein each of the lithium sources can provide lithium during sintering and may contribute to decrease in lithium loss during the sintering process. Lithium that is provided to a green film during sintering may be in the form of an external source of lithium vapor or may be from in-situ generated lithium vapor, such as that from a setter.

Also included in the slurry are lithium stuffed garnet particles as described herein, including lithium stuffed garnet particles having particle size distributions as described herein.

Also included in the slurry are lithium stuffed garnet particles as described herein, including lithium stuffed garnet particles having d₅₀ particle size distributions as described herein.

In some examples, including any of the foregoing, the porosity of the sintered lithium-stuffed garnet thin film is less than 10% by volume. In some examples, the porosity of the sintered lithium-stuffed garnet thin film is less than 9% by volume. In some examples, the porosity of the sintered lithium-stuffed garnet thin film is less than 8% by volume. In some examples, the porosity of the sintered lithium-stuffed garnet thin film is less than 7% by volume. In some examples, the porosity of the sintered lithium-stuffed garnet thin film is less than 6% by volume. In some examples, the porosity of the sintered lithium-stuffed garnet thin film is less than 5% by volume. In some examples, the porosity of the sintered lithium-stuffed garnet thin film is less than 4% by volume. In some examples, the porosity of the sintered lithium-stuffed garnet thin film is less than 3% by volume. In some examples, the porosity of the sintered lithium-stuffed garnet thin film is less than 2% by volume. In some examples, the porosity of the sintered lithium-stuffed garnet thin film is less than 1% by volume. In some examples, the green film porosity is determined by image analysis of cross-section FIB images.

A surface flatness is measured, as defined herein, on the side of the film that was closest to the second setter during the sintering step. In such instances, the surface flatness is measured on the side of the film that was in direct contact with the first setter during the sintering step.

Provided herein is a sintered lithium-stuffed garnet thin film made by a process described above. In some instances, the sintered lithium-stuffed garnet thin film has a surface flatness of less than 500 μm, 450 μm, 400 μm, 350 μm, 300 μm, 250 μm, 200 μm, 150 μm, 100 μm, 50 μm, 40 μm, 30 μm, 20 μm or 10 μm. In some instances, the sintered lithium-stuffed garnet thin film has a surface flatness of less than 500 μm. In some instances, the sintered lithium-stuffed garnet thin film has a surface flatness of less than 450 μm. In some instances, the sintered lithium-stuffed garnet thin film has a surface flatness of less than 400 μm. In some instances, the sintered lithium-stuffed garnet thin film has a surface flatness of less than 350 μm. In some instances, the sintered lithium-stuffed garnet thin film has a surface flatness of less than 300 μm. In some instances, the sintered lithium-stuffed garnet thin film has a surface flatness of less than 250 μm. In some instances, the sintered lithium-stuffed garnet thin film has a surface flatness of less than 200 μm. In some instances, the sintered lithium-stuffed garnet thin film has a surface flatness of less than 150 μm. In some instances, the sintered lithium-stuffed garnet thin film has a surface flatness of less than 100 μm. In some instances, the sintered lithium-stuffed garnet thin film has a surface flatness of less than 50 μm. In some instances, the sintered lithium-stuffed garnet thin film has a surface flatness of less than 40 μm. In some instances, the sintered lithium-stuffed garnet thin film has a surface flatness of less than 30 μm. In some instances, the sintered lithium-stuffed garnet thin film has a surface flatness of less than 20 μm. In some instances, the sintered lithium-stuffed garnet thin film has a surface flatness of less than 10 μm. In certain cases, the sintered lithium-stuffed garnet thin film comprises less than 5% v/v LiAlO₂. In certain cases, the sintered lithium-stuffed garnet thin film comprises less than 4% v/v LiAlO₂. In certain cases, the sintered lithium-stuffed garnet thin film comprises less than 3% v/v LiAlO₂. In certain cases, the sintered lithium-stuffed garnet thin film comprises less than 2% v/v LiAlO₂. In certain cases, the sintered lithium-stuffed garnet thin film comprises less than 1% v/v LiAlO₂.

In some examples, the process maintains the flatness of the green film. In certain instances, the process produces a sintered lithium-stuffed garnet solid electrolyte thin films less than 100 microns thick and more than 1 nm thick. In certain instances, the process produces a sintered lithium-stuffed garnet solid electrolyte thin films that has a bulk ASR from between 0.1 Ω·cm² to 10 Ω·cm² at 50° C. In some cases, the sintered film has a surface area that is 30% less than the surface area of the green film.

Provided herein is a sintered lithium-stuffed garnet thin film made by a process described above. In some instances, the sintered lithium-stuffed garnet thin film has a surface flatness of less than 500 μm, 450 μm, 400 μm, 350 μm, 300 μm, 250 μm, 200 μm, 150 μm, 100 μm, 50 μm, 40 μm, 30 μm, 20 μm or 10 μm. In certain cases, the surface flatness is measured, as defined herein, on the side of the film that was closest to the second setter during the sintering step. In some cases, the surface flatness is measured on the side of the film that was in direct contact with the first setter during the sintering step.

In some instances, the sintered lithium-stuffed garnet thin film comprises less than 1% v/v secondary phases. In some instances, the sintered lithium-stuffed garnet thin film comprises less than 1% v/v LiAlO₂.

Provided herein is an electrochemical cell or rechargeable battery including the sintered lithium-stuffed garnet thin film described herein.

Provided herein is an electrochemical cell or rechargeable battery comprising the sintered lithium-stuffed garnet thin film described above.

In some examples, including any of the foregoing, the green film has a density greater than 2 g/cm³ as measured by geometric density. In some examples, the green film has a density greater than 2.1 g/cm³ as measured by geometric density. In some examples, the green film has a density greater than 2.2 g/cm³ as measured by geometric density. In some examples, the green film has a density greater than 2.3 g/cm³ as measured by geometric density. In some examples, the green film has a density greater than 2.4 g/cm³ as measured by geometric density. In some examples, the green film has a density greater than 2.5 g/cm³ as measured by geometric density. In some examples, the green film has a density greater than 2.6 g/cm³ as measured by geometric density. In some examples, the green film has a density greater than 2.7 g/cm³ as measured by geometric density. In some examples, the green film has a density greater than 2.8 g/cm³ as measured by geometric density. In some examples, the green film has a density greater than 2.9 g/cm³ as measured by geometric density. In some examples, the green film has a density greater than 3.0 g/cm³ as measured by geometric density. In some examples, the green film has a density greater than 3.1 g/cm³ as measured by geometric density. In some examples, the green film has a density greater than 3.5 g/cm³ as measured by geometric density. In some examples, the green film has a density greater than 4.0 g/cm³ as measured by geometric density. In some examples, the green film has a density greater than 4.5 g/cm³ as measured by geometric density. In some examples, the green film has a density greater than 4.7 g/cm³ as measured by geometric density.

In some examples, including any of the foregoing, the green film density as measured by the geometric process is between 2.5 g/cm³ and 4.7 g/cm³. In some examples, the green film density as measured by the geometric process is between 2.6 g/cm³ and 3.2 g/cm³. In some examples, the green film density as measured by the geometric process is between 2.7 g/cm³ and 3.2 g/cm³. In some examples, the green film density as measured by the geometric process is between 2.8 g/cm³ and 3.2 g/cm³. In some examples, the green film density as measured the geometric process is between 2.9 g/cm³ and 3.2 g/cm³. In some examples, the green film density as measured by the geometric process is between 3.0 g/cm³ and 3.2 g/cm³. In some examples, the green film density as measured by the geometric process is between 3.1 g/cm³ and 3.2 g/cm³.

In some examples, the green film density as measured by Archimedes process is greater than 2 g/cm³. In some examples, the green film density as measured by Archimedes process is greater than 2.1 g/cm³. In some examples, the green film density as measured by Archimedes process is greater than 2.2 g/cm³. In some examples, the green film density as measured by Archimedes process is greater than 2.3 g/cm³. In some examples, the green film density as measured by Archimedes process is greater than 2.4 g/cm³. In some examples, the green film density as measured by Archimedes process is greater than 2.5 g/cm³. In some examples, the green film density as measured by Archimedes process is greater than 2.6 g/cm³. In some examples, the green film density as measured by Archimedes process is greater than 2.7 g/cm³. In some examples, the green film density as measured by Archimedes process is greater than 2.8 g/cm³. In some examples, the green film density as measured by Archimedes process is greater than 2.9 g/cm³. In some examples, the green film density as measured by Archimedes process is greater than 3.0 g/cm³. In some examples, the green film density as measured by Archimedes process is greater than 3.1 g/cm³. In some examples, the green film density as measured by Archimedes process is greater than 3.5 g/cm³. In some examples, the green film density as measured by Archimedes process is greater than 4.0 g/cm³. In some examples, the green film density as measured by Archimedes process is greater than 4.5 g/cm³. In some examples, the green film density as measured by Archimedes process is greater than 4.7 g/cm³.

In some examples, the green film density as measured by Archimedes process is between 2 g/cm³ and 4.7 g/cm³. In some examples, the green film density as measured by Archimedes process is between 2 g/cm³ and 3.2 g/cm³. In some examples, the green film density as measured by Archimedes process is between 2.5 g/cm³ and 3.2 g/cm³. In some examples, the green film density as measured by Archimedes process is between 2.6 g/cm³ and 3.2 g/cm³. In some examples, the green film density as measured by Archimedes process is between 2.7 g/cm³ and 3.2 g/cm³. In some examples, the green film density as measured by Archimedes process is between 2.8 g/cm³ and 3.2 g/cm³. In some examples, the green film density as measured by Archimedes process is between 2.9 g/cm³ and 3.2 g/cm³. In some examples, the green film density as measured by Archimedes process is between 3.0 g/cm³ and 3.2 g/cm³. In some examples, the green film density as measured by Archimedes process is between 3.1 g/cm³ and 3.2 g/cm³.

In some embodiments, the ceramic loading (i.e., the amount of solid ceramic or source powder present in the green film) of the green film is greater than a certain percentage by volume after drying. In some examples, the ceramic loading of the green film is greater than 40 vol %. In some other examples, the ceramic loading of the green film is greater than 50 vol %. In certain examples, the ceramic loading of the green film is greater than 55 vol %. In some examples, the ceramic loading of the green film is greater than 60 vol %. In some other examples, the ceramic loading of the green film is greater than 61 vol %. In some examples, the ceramic loading of the green film is greater than 62 vol %. In some examples, the ceramic loading of the green film is greater than 63 vol %. In some examples, the ceramic loading of the green film is greater than 64 vol %. In some examples, the ceramic loading of the green film is greater than 65 vol %. In some examples, the ceramic loading of the green film is greater than 66 vol %. In some examples, the ceramic loading of the green film is greater than 67 vol %. In some examples, the ceramic loading of the green film is greater than 68 vol %. In some examples, the ceramic loading of the green film is greater than 69 vol %. In some examples, the ceramic loading of the green film is greater than 70 vol %. In some examples, the ceramic loading of the green film is greater than 71 vol %. In some examples, the ceramic loading of the green film is greater than 72 vol %. In some examples, the ceramic loading of the green film is greater than 73 vol %. In some examples, the ceramic loading of the green film is greater than 74 vol %. In some examples, the ceramic loading of the green film is greater than 75 vol %. In some examples, the ceramic loading of the green film is greater than 76 vol %. In some examples, the ceramic loading of the green film is greater than 77 vol %. In some examples, the ceramic loading of the green film is greater than 78 vol %. In some examples, the ceramic loading of the green film is greater than 79 vol %. In some examples, the ceramic loading of the green film is greater than 80 vol %. Herein, ceramic loading is the same as solid loading if the ceramic is the only solid present. In some examples, including any of the foregoing, the maximum solid loading is 80 vol %. In some examples, including any of the foregoing, the maximum solid loading is 85 vol %. In some examples, including any of the foregoing, the maximum solid loading is 90 vol %. In some examples, including any of the foregoing, the maximum solid loading is 95 vol %.

In some examples, the ceramic loading of the green film is between 50 vol % and 80 vol %. In some examples, the ceramic loading of the green film is between 55 vol % and 80 vol %. In some examples, the ceramic loading of the green film is between 60 vol % and 80 vol %. In some examples, the ceramic loading of the green film is between 61 vol % and 80 vol %. In some examples, the ceramic loading of the green film is between 62 vol % and 80 vol %. In some examples, the ceramic loading of the green film is between 63 vol % and 80 vol %. In some examples, the ceramic loading of the green film is between 64 vol % and 80 vol %. In some examples, the ceramic loading of the green film is between 65 vol % and 80 vol %. In some examples, the ceramic loading of the green film is between 66 vol % and 80 vol %. In some examples, the ceramic loading of the green film is between 67 vol % and 80 vol %. In some examples, the ceramic loading of the green film is between 68 vol % and 80 vol %. In some examples, the ceramic loading of the green film is between 69 vol % and 80 vol %. In some examples, the ceramic loading of the green film is between 70 vol % and 80 vol %. In some examples, the ceramic loading of the green film is between 71 vol % and 80 vol %. In some examples, the ceramic loading of the green film is between 72 vol % and 80 vol %. In some examples, the ceramic loading of the green film is between 73 vol % and 80 vol %. In some examples, the ceramic loading of the green film is between 74 vol % and 80 vol %. In some examples, the ceramic loading of the green film is between 75 vol % and 80 vol %. In some examples, the ceramic loading of the green film is between 76 vol % and 80 vol %. In some examples, the ceramic loading of the green film is between 77 vol % and 80 vol %. In some examples, the ceramic loading of the green film is between 78 vol % and 80 vol %. In some examples, the ceramic loading of the green film is between 79 vol % and 80 vol %. In some examples, the ceramic loading of the green film is between 80 vol % and 81 vol %.

In some examples, the ceramic loading of the green film is between 50 vol % and 90 vol %. In some examples, the ceramic loading of the green film is between 55 vol % and 90 vol %. In some examples, the ceramic loading of the green film is between 60 vol % and 90 vol %. In some examples, the ceramic loading of the green film is between 61 vol % and 90 vol %. In some examples, the ceramic loading of the green film is between 62 vol % and 90 vol %. In some examples, the ceramic loading of the green film is between 63 vol % and 90 vol %. In some examples, the ceramic loading of the green film is between 64 vol % and 90 vol %. In some examples, the ceramic loading of the green film is between 65 vol % and 90 vol %. In some examples, the ceramic loading of the green film is between 66 vol % and 90 vol %. In some examples, the ceramic loading of the green film is between 67 vol % and 90 vol %. In some examples, the ceramic loading of the green film is between 68 vol % and 90 vol %. In some examples, the ceramic loading of the green film is between 69 vol % and 90 vol %. In some examples, the ceramic loading of the green film is between 70 vol % and 90 vol %. In some examples, the ceramic loading of the green film is between 71 vol % and 90 vol %. In some examples, the ceramic loading of the green film is between 72 vol % and 90 vol %. In some examples, the ceramic loading of the green film is between 73 vol % and 90 vol %. In some examples, the ceramic loading of the green film is between 74 vol % and 90 vol %. In some examples, the ceramic loading of the green film is between 75 vol % and 90 vol %. In some examples, the ceramic loading of the green film is between 76 vol % and 90 vol %. In some examples, the ceramic loading of the green film is between 77 vol % and 90 vol %. In some examples, the ceramic loading of the green film is between 78 vol % and 90 vol %. In some examples, the ceramic loading of the green film is between 79 vol % and 90 vol %. In some examples, the ceramic loading of the green film is between 80 vol % and 91 vol %.

In some examples, the ceramic loading of the green film is between 50 vol % and 95 vol %. In some examples, the ceramic loading of the green film is between 55 vol % and 95 vol %. In some examples, the ceramic loading of the green film is between 60 vol % and 95 vol %. In some examples, the ceramic loading of the green film is between 61 vol % and 95 vol %. In some examples, the ceramic loading of the green film is between 62 vol % and 95 vol %. In some examples, the ceramic loading of the green film is between 63 vol % and 95 vol %. In some examples, the ceramic loading of the green film is between 64 vol % and 95 vol %. In some examples, the ceramic loading of the green film is between 65 vol % and 95 vol %. In some examples, the ceramic loading of the green film is between 66 vol % and 95 vol %. In some examples, the ceramic loading of the green film is between 67 vol % and 95 vol %. In some examples, the ceramic loading of the green film is between 68 vol % and 95 vol %. In some examples, the ceramic loading of the green film is between 69 vol % and 95 vol %. In some examples, the ceramic loading of the green film is between 70 vol % and 95 vol %. In some examples, the ceramic loading of the green film is between 71 vol % and 95 vol %. In some examples, the ceramic loading of the green film is between 72 vol % and 95 vol %. In some examples, the ceramic loading of the green film is between 73 vol % and 95 vol %. In some examples, the ceramic loading of the green film is between 74 vol % and 95 vol %. In some examples, the ceramic loading of the green film is between 75 vol % and 95 vol %. In some examples, the ceramic loading of the green film is between 76 vol % and 95 vol %. In some examples, the ceramic loading of the green film is between 77 vol % and 95 vol %. In some examples, the ceramic loading of the green film is between 78 vol % and 95 vol %. In some examples, the ceramic loading of the green film is between 79 vol % and 95 vol %. In some examples, the ceramic loading of the green film is between 80 vol % and 96 vol %.

In some examples, the thickness (t) of the green film satisfies the equation 10 μm≤t≤500 μm. In some examples, t is about 10 μm. In some examples, t is about 25 μm. In some examples, t is about 50 μm. In some examples, t is about 100 μm. In some examples, t is about 150 μm. In some examples, t is about 200 μm. In some examples, t is about 250 μm. In some examples, t is about 300 μm. In some examples, t is about 350 μm. In some examples, t is about 400 μm. In some examples, t is about 450 μm. In some examples, t is about 500 μm.

In some examples, the thickness (t) of the green film satisfies the equation 10 μm≤t≤500 μm. In some examples, t is about 10 μm. In some examples, t is about 15 μm. In some examples, t is about 20 μm. In some examples, t is about 25 μm. In some examples, t is about 30 μm. In some examples, t is about 35 μm. In some examples, t is about 40 μm. In some examples, t is about 50 μm. In some examples, t is 100 μm. In some examples, t is 150 μm.

In some examples, the thickness (t) of the green film satisfies the equation 10 μm≤t≤500 μm. In some of such instances, t is about 100 μm. In some of such instances, t is about 25 μm.

In some embodiments, the instant specification provides improved methods for sintering green films. In some embodiments, the green films that are sintered by the methods described herein have a density of at least 2 gm/cm³ as measured by geometric density. In some embodiments, the green films described herein comprise a lithium-stuffed garnet powder and a binder.

### F. PROCESSES FOR MAKING SINTERED FILMS

In some processes set forth herein, the processes include casting a tape of ceramic source powder onto a substrate (e.g., porous or nonporous alumina, zirconia, garnet, alumina-zirconia, lanthanum alumina-zirconia). In some examples, the tape is prepared on a substrate such as a silicone coated substrate (e.g., silicone coated Mylar, or silicone coated Mylar on alumina).

Some tape casting processes include those set forth in Mistler, R. E. and Twiname, E. R, Tape Casting: Theory and Practice, 1^{st} Edition Wiley-American Ceramic Society; 1 edition (Dec. 1, 2000). Other casting processes and materials are set forth in U.S. Pat. No. 5,256,609, to Dolhert, L. E., and entitled CLEAN BURNING GREEN FILM CAST SYSTEM USING ATACTIC POLYPROPYLENE BINDER. Other casting processes include those described in D. J. Shanefield Organic Additives and Ceramic Processing, Springer Science & Business Media, (Mar. 9, 2013).

In some examples, including any of the foregoing, the cast film is subjected to high pressure and/or calendered prior to drying and sintering. The high pressure may be isostatic lamination at room temperature or elevated temperature up to 90° C. The temperature may be about 25° C., about 30° C., about 35° C., about 40° C., about 45° C., about 50° C., about 55° C., about 60° C., about 65° C., about 70° C., about 75° C., about 80° C., about 85° C., or about 90° C. The pressure may be about 10 pounds-per-square-inch (PSI), about 20 PSI, about 40 PSI, about 60 PSI, about 80 psi, about 100 PSI, about 120 psi, about 140 psi, about 160 PSI, about 180 psi, about 200 PSI, about 240 PSI, about 280 PSI, about 300 PSI, about 330 PSI, about 360 PSI, about 390 PSI, about 400 PSI, about 440 PSI, about 480 psi, about 500 PSI, about 550 psi, about 600 PSI, about 650 psi, about 700 PSI, about 750 PSI, about 800 PSI, about 850 PSI, about 900 PSI, about 950 PSI, about 1000 PSI, about 1.1 PSI, about 1.2 PSI, about 1.3 PSI, about 1.4 PSI, about 1.5 PSI, about 1.6 PSI, about 1.7 PSI, about 1.8 PSI, about 1.9 PSI, about 2 PSI, about 2.2 PSI, about 2.4 PSI, about 2.6 PSI, about 2.8 PSI, about 3 PSI, about 3.3 PSI, about 3.6 PSI, about 3.9 PSI, about 4 PSI, about 4.4 PSI, about 4.8 PSI, about 5 PSI, about 5.5 PSI, about 6 PSI, about 6.5 PSI, about 7 PSI, about 7.5 PSI, about 8 PSI, or about 8.5 PSI.

In some examples, including any of the foregoing, the cast film is subjected to high pressure and/or calendered prior to drying and sintering. The high pressure may be isostatic lamination at room temperature or elevated temperature up to 90° C. The temperature may be 25° C., 30° C., 35° C., 40° C., 45° C., 50° C., 55° C., 60° C., 65° C., 70° C., 75° C., 80° C., 85° C., or 90° C. The pressure may be 10 pounds-per-square-inch (PSI), 20 PSI, 40 PSI, 60 PSI, 80 psi, 100 PSI, 120 psi, 140 psi, 160 PSI, 180 psi, 200 PSI, 240 PSI, 280 PSI, 300 PSI, 330 PSI, 360 PSI, 390 PSI, 400 PSI, 440 PSI, 480 psi, 500 PSI, 550 psi, 600 PSI, 650 psi, 700 PSI, 750 PSI, 800 PSI, 850 PSI, 900 PSI, 950 PSI, 1000 PSI, 1.1 PSI, 1.2 PSI, 1.3 PSI, 1.4 PSI, 1.5 PSI, 1.6 PSI, 1.7 PSI, 1.8 PSI, 1.9 PSI, 2 PSI, 2.2 PSI, 2.4 PSI, 2.6 PSI, 2.8 PSI, 3 PSI, 3.3 PSI, 3.6 PSI, 3.9 PSI, 4 PSI, 4.4 PSI, 4.8 PSI, 5 PSI, 5.5 PSI, 6 PSI, 6.5 PSI, 7 PSI, 7.5 PSI, 8 PSI, or 8.5 PSI.

In some examples, including any of the foregoing, the processes set forth herein include drying. In some processes, drying includes controlling the temperature of the green film by, for example, using a heated bed on which to place or deposit casted film, infrared (IR) heating, or convection heating of casted tape. In some processes, drying may include using environmental controls such as, but not limited to, stagnant and, or, flowing environment (e.g., atmospheric air, dry air, inert gas, nitrogen gas, argon gas) to manage or to control the amount of solvent in the drying ambient. In these processes, the drying is used to control the rate of solvent removal and to ensure that the cast film dries from the substrate to the surface as opposed to from the surface to the substrate.

In one embodiment, the instant disclosure sets forth processes for casting a green film, in which the processes include, generally, (1) providing at least one source powder, (2) calcining the source powder in a non-reactive environment to form a calcined powder, (3) milling the at least one calcined powder to prepare a slurry with an aprotic solvent and a dispersant in a non-reactive environment, (4) mixing the slurry with a binder solution in a non-reactive environment, (5) casting the slurry to form a green film in a non-reactive environment, (6) drying the green film in a non-reactive environment to achieve a high density green film, and (7) sintering the green film to form a sintered thin film. In some embodiments, the process further comprises filtering the slurry in a non-reactive environment.

In one embodiment, the instant disclosure sets forth processes for casting a green film, in which the processes include, generally, (1) providing at least one calcined powder, (2) milling the at least one calcined powder to prepare a slurry with an aprotic solvent, a dispersant and a binder, in a non-reactive environment, (3) casting the slurry to form a green film in a non-reactive environment, (4) drying the green film in a non-reactive environment to achieve a high density green film, and (5) sintering the green film to form a sintered thin film. In some embodiments, the process further comprises filtering the slurry in a non-reactive environment.

In one embodiment, the instant disclosure sets forth processes for casting a green film, in which the processes include, generally, (1) providing a slurry comprising at least one calcined powder with an aprotic solvent, a dispersant and a binder, in a non-reactive environment, (2) casting the slurry to form a green film in a non-reactive environment, (3) drying the green film in a non-reactive environment to achieve a high density green film, and (4) sintering the green film to form a sintered thin film. In some embodiments, the process further comprises filtering the slurry in a non-reactive environment.

In some examples, including any of the foregoing, the instant disclosure sets forth processes for casting a green film, in which the processes include, generally, (1) casting a slurry comprising at least one calcined powder with an aprotic solvent, a dispersant and a binder, in a non-reactive environment to form a green film, (2) drying the green film in a non-reactive environment to achieve a high density green film, and (3) sintering the green film to form a sintered thin film. In some embodiments, the process further comprises filtering the slurry in a non-reactive environment.

In some examples, including any of the foregoing, the green films cast by the processes set forth herein are high density films. Another way to describe this high density is to note that the films have a high solid loading, or a high amount of solid material in the green film, with the remainder being solvent or gas. A high amount of solid material or solid loading is at least 50% by weight.

In some examples, including any of the foregoing, green films are cast from slurries made with downsized or milled ceramic materials. They may contain refractory and/or ceramic materials that are formulated as ceramic particles intimately mixed with a binder. The purpose of this binder is, in part, to assist the sintering of the ceramic particles to result in a uniform and thin film, or layer, of refractory or ceramic post-sintering. During the sintering process, the binder is removed from the green film in a step. In some examples, this binder is removed by heating the film to a temperature less than 700° C., less than 450° C., less than 400° C., less than 350° C., less than 300° C., less than 250° C., or in some examples less than 200° C., or in some examples less than 150° C., or in some examples less than 100° C. During this binder removal process, the oxygen and water partial pressures may be controlled. This process may include multiple stages. The binder may be removed by combustion. The binder may be removed by vaporization.

In some examples, including any of the foregoing, the green film set forth herein can be made by a variety of processes. In some processes a slurry containing a calcined source powder is prepared in a non-reactive environment using anhydrous aprotic solvents; this slurry is cast onto a substrate or a setter plate, and then this slurry is dried and sintered to prepare a dried and sintered solid ion conducting ceramic thin film. In certain examples, the substrate may include, for example, Mylar, silicone coated Mylar, surfaces coated with polymers, surface modified polymers, or surface assembled monolayers adhered, attached, or bonded to a surface.

Methods of preparing green films suitable for the sintering protocols described herein are disclosed in, for example, WO2017015511A1, the published version of PCT/US2016/043428, filed Jul. 21, 2016, which disclosure is incorporated herein by reference in its entirety for all purposes. In some examples, the green films are prepared by the processes herein, and those set forth in WO 2016/168691; WO 2016/168723; US 2017/0062873; US 2017/0153060; and US20180045465A1; and U.S. Pat. Nos. 9,806,372 B2; 9,966,630 B2 9,970,711 B2 10,008,742 B2, each of which is incorporated by reference in their entirety.

### G. MILLING

In some embodiments, the processes herein include processes steps related to nanodimensioning the constituents of the lithium-stuffed garnet green film or a setter green film. In some embodiments, the processes herein include processes steps related to mixing and, or, process steps related to milling. Milling includes, but is not limited to, ball milling. Milling may be dry milling, or the material to be milled may be wetted with a solvent prior to milling. Milling processes may use anhydrous solvents under non-reactive conditions such as, for example but not limited to, toluene, xylene, ethyl acetate, tetrahydrofuran, dioxane, and 1,2-dimethoxyethane, or combinations thereof.

In some examples, including any of the foregoing, the milling is used to downsize the materials in a slurry, such as but not limited to the lithium-stuffed garnet. Once downsized to the right size, the lithium-stuffed garnet may be sintered to provide for high densities and low porosities.

In some examples, including any of the foregoing, the milling is ball milling. In some examples, the milling is horizontal milling. In some examples, the milling is attritor milling. In some examples, the milling is immersion milling. In some examples, the milling is jet milling. In some examples, the milling is steam jet milling. In some examples, the milling is high energy milling.

In some examples, including any of the foregoing, the high energy milling process results in a milled particle size distribution with d₅₀ of approximately 100 nm as measured by light scattering. In some examples, the high energy milling process is used to achieve a particle size distribution with d₅₀ of about 750 nm as measured by light scattering. In some examples, the high energy milling process is used to achieve a particle size distribution with d₅₀ of about 150 nm as measured by light scattering. In some examples, the high energy milling process is used to achieve a particle size distribution with d₅₀ of about 200 nm as measured by light scattering. In some examples, the high energy milling process is used to achieve a particle size distribution with d₅₀ of about 250 nm as measured by light scattering. In some examples, the high energy milling process is used to achieve a particle size distribution with d₅₀ of about 300 nm as measured by light scattering. In some examples, the high energy milling process is used to achieve a particle size distribution with d₅₀ of about 350 nm as measured by light scattering. In some examples, the high energy milling process is used to achieve a particle size distribution with d₅₀ of about 400 nm as measured by light scattering. In some examples, the high energy milling process is used to achieve a particle size distribution with d₅₀ of about 450 nm as measured by light scattering. In some examples, the high energy milling process is used to achieve a particle size distribution with d₅₀ of about 500 nm as measured by light scattering. In some examples, the high energy milling process is used to achieve a particle size distribution with d₅₀ of about 550 nm as measured by light scattering. In some examples, the high energy milling process is used to achieve a particle size distribution with d₅₀ of about 600 nm as measured by light scattering. In some examples, the high energy milling process is used to achieve a particle size distribution with d₅₀ of about 650 nm as measured by light scattering. In some examples, the high energy milling process is used to achieve a particle size distribution with d₅₀ of about 700 nm as measured by light scattering. In some examples, the high energy milling process is used to achieve a particle size distribution with d₅₀ of about 800 nm as measured by light scattering. In some examples, the high energy milling process is used to achieve a particle size distribution with d₅₀ of about 850 nm as measured by light scattering. In some examples, the high energy milling process is used to achieve a particle size distribution with d₅₀ of about 900 nm as measured by light scattering. In some examples, the high energy milling process is used to achieve a particle size distribution with d₅₀ of about 950 nm as measured by light scattering. In some examples, the high energy milling process is used to achieve a particle size distribution with d₅₀ of about 1000 nm as measured by light scattering. In some examples, the milling process is used to achieve a particle size distribution span (d₉₀−d₁₀)/d₅₀ of about 10 or less. In some examples, the milling process is used to achieve a particle size distribution span (d₉₀−d₁₀)/d₅₀ of about 9 or less. In some examples, the milling process is used to achieve a particle size distribution span (d₉₀−d₁₀)/d₅₀ of about 8 or less. In some examples, the milling process is used to achieve a particle size distribution span (d₉₀−d₁₀)/d₅₀ of about 7 or less. In some examples, the milling process is used to achieve a particle size distribution span (d₉₀−d₁₀)/d₅₀ of about 6 or less. In some examples, the milling process is used to achieve a particle size distribution span (d₉₀−d₁₀)/d₅₀ of about 5 or less. In some examples, the milling process is used to achieve a particle size distribution span (d₉₀−d₁₀)/d₅₀ of about 4 or less. In some examples, the milling process is used to achieve a particle size distribution span (d₉₀−d₁₀)/d₅₀ of about 3 or less. In some examples, the milling process is used to achieve a particle size distribution span (d₉₀−d₁₀)/d₅₀ of about 2 or less. In some examples, the milling process is used to achieve a particle size distribution span (d₉₀−d₁₀)/d₅₀ of about 1.8 or less. In some examples, the milling process is used to achieve a particle size distribution span (d₉₀−d₁₀)/d₅₀ of about 1.6 or less. In some examples, the milling process is used to achieve a particle size distribution span (d₉₀−d₁₀)/d₅₀ of about 1.4 or less. In some examples, the milling process is used to achieve a particle size distribution span (d₉₀-d₁₀)/d₅₀ of about 1.2 or less. In some examples, the milling process is used to achieve a particle size distribution span (d₉₀-d₁₀)/d₅₀ of about 1.1 or less. In some examples, the milling process is used to achieve a particle size distribution span (d₉₀-d₁₀)/d₅₀ of about 1.0 or less. In some examples, the milling process is used to achieve a particle size distribution span (d₉₀-d₁₀)/d₅₀ of about 0.9 or less. In some examples, the milling process is used to achieve a particle size distribution span (d₉₀−d₁₀)/d₅₀ of about 0.8 or less. In some examples, the milling process is used to achieve a particle size distribution span (d₉₀-d₁₀)/d₅₀ of about 0.7 or less.

In some examples, the aprotic solvent used for milling is tetrahydrofuran. In another example, the aprotic solvent is 1,2-dimethoxyethane. In another example, the solvent is toluene. In another example, the solvent is xylene. In other example, the solvent is dioxane. In yet other example, the solvent is dimethyl sulfoxide. In another example, the solvent is methylene chloride. In other example, the solvent is benzene. In other example, the solvent is N-methyl-2-pyrrolidone. In another example, the solvent is dimethyl formamide.

In some examples, the milling includes a high energy wet milling process with 0.3 mm yttria stabilized zirconium oxide grinding media beads. In some examples, ball milling, horizontal milling, attritor milling, or immersion milling can be used. In some examples, using a high energy milling process produces a particle size distribution of about d₅₀˜100 nm to 5000 nm.

In some examples, the milling may include a classifying step such as sieving, centrifugation, or other techniques to separate particles of different size and/or mass.

### H. SINTERING

In one aspect, provided herein is a process for making a sintered lithium-stuffed garnet thin film, wherein the process includes:
(a) providing a green film comprising lithium-stuffed garnet powder and a binder,
(b) providing a first setter and a second setter, wherein the first setter and second setter each comprise at least 5 atomic % lithium (Li) per setter;
(c) placing the green film on the first setter;
(d) placing the second setter within 2 cm of the green film but not in contact with the green film; and
(e) heating the green film to at least 900° C.

In some examples, including any of the foregoing, the green film that is heated has an initial density >2 g/cm³ as measured by geometric density. In one instance, step (b) occurs before step (a). In a different instance, step (a) occurs before step (b). In some instances, the process occurs in the order of step (a), followed by step (b), followed by step (c), followed by step (d), and followed by step (e).

In some examples, including any of the foregoing, prior to step (d), the second setter contacts the green film. In another instance, after step (e), the second setter contacts the green film. In some examples, the second setter contacts the green film until the binder is removed prior to step (d). In certain examples, the binder is removed by combustion, evaporation, or a combination thereof.

In some examples, including any of the foregoing, step (e) comprises heating the first setter to at least 900° C. In another example, step (e) comprises heating the second setter to at least 900° C. In another example, step (e) comprises heating the second setter to less than 1,500° C.

In some examples, including any of the foregoing, prior to step (a), the process comprises providing a slurry comprising lithium-stuffed garnet powder and a binder.

In some examples, including any of the foregoing, steps (d) and (e) occur concurrently.

In some examples, including any of the foregoing, in step (d), the second setter is substantially parallel to the first setter. In one example, in step (d), the second setter is parallel to the first setter. In other examples, the second setter may be angled to the first setter (e.g., up to ±15 degrees deviated from the parallel position).

In some examples, including any of the foregoing, the average distance between top surface of the bottom setter and the bottom surface of the top setter is 2 cm or less, or 1 cm or less, or 0.5 cm or less. In some of these embodiments, the distance between the top surface of the bottom setter and the bottom surface of the top setter is greater than 0 cm. In some embodiments, the average distance between top surface of the bottom setter and the bottom surface of the top setter is about 10 μm-1 mm. In some instances, the first setter has a top surface, the second setter has a bottom surface, and the average distance between the top surface of the first setter and the bottom surface of the second setter is about 15 μm-750 μm. In some instances, the first setter has a top surface, the second setter has a bottom surface, and the average distance between top surface of the first setter and the bottom surface of the second setter is about 10 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 125 μm, 135 μm, 150 μm, 175 μm, 200 μm, 225 μm, 250 μm, 300 μm, 350 μm, 400 μm, 500 μm, 550 μm, 650 μm, 700 μm, or 750 μm. In some instances, the first setter has a top surface, the second setter has a bottom surface, and the average distance between top surface of the first setter and the bottom surface of the second setter is from about 10 μm, 25 μm, 35 μm, 50 μm, 75 μm, 100 μm, 125 μm, or 150 μm, to about 200 μm, 250 μm, 300 μm, 350 μm, 400 μm, 500 μm, 550 μm, 650 μm, 700 μm, or 750 μm. In some instances, the first setter has a top surface, the second setter has a bottom surface, and the average distance between top surface of the first setter and the bottom surface of the second setter is about 10 μm. In some instances, the first setter has a top surface, the second setter has a bottom surface, and the average distance between top surface of the first setter and the bottom surface of the second setter is about 20 μm. In some instances, the first setter has a top surface, the second setter has a bottom surface, and the average distance between top surface of the first setter and the bottom surface of the second setter is about 25 μm. In some instances, the first setter has a top surface, the second setter has a bottom surface, and the average distance between top surface of the first setter and the bottom surface of the second setter is about 30 μm. In some instances, the first setter has a top surface, the second setter has a bottom surface, and the average distance between top surface of the first setter and the bottom surface of the second setter is about 35 μm. In some instances, the first setter has a top surface, the second setter has a bottom surface, and the average distance between top surface of the first setter and the bottom surface of the second setter is about 40 μm. In some instances, the first setter has a top surface, the second setter has a bottom surface, and the average distance between top surface of the first setter and the bottom surface of the second setter is about 50 μm. In some instances, the first setter has a top surface, the second setter has a bottom surface, and the average distance between top surface of the first setter and the bottom surface of the second setter is about 100 μm. In some instances, the first setter has a top surface, the second setter has a bottom surface, and the average distance between top surface of the first setter and the bottom surface of the second setter is about 125 μm. In some instances, the first setter has a top surface, the second setter has a bottom surface, and the average distance between top surface of the first setter and the bottom surface of the second setter is about 150 μm. In some instances, the first setter has a top surface, the second setter has a bottom surface, and the average distance between top surface of the first setter and the bottom surface of the second setter is about 200 μm. In some instances, the first setter has a top surface, the second setter has a bottom surface, and the average distance between top surface of the first setter and the bottom surface of the second setter is about 250 μm. In some instances, the first setter has a top surface, the second setter has a bottom surface, and the average distance between top surface of the first setter and the bottom surface of the second setter is about 300 μm. In some instances, the first setter has a top surface, the second setter has a bottom surface, and the average distance between top surface of the first setter and the bottom surface of the second setter is about 350 μm. In some instances, the first setter has a top surface, the second setter has a bottom surface, and the average distance between top surface of the first setter and the bottom surface of the second setter is about 400 μm. In some instances, the first setter has a top surface, the second setter has a bottom surface, and the average distance between top surface of the first setter and the bottom surface of the second setter is about 450 μm. In some instances, the first setter has a top surface, the second setter has a bottom surface, and the average distance between top surface of the first setter and the bottom surface of the second setter is about 500 μm. In some instances, the first setter has a top surface, the second setter has a bottom surface, and the average distance between top surface of the first setter and the bottom surface of the second setter is about 550 μm. In some instances, the first setter has a top surface, the second setter has a bottom surface, and the average distance between top surface of the first setter and the bottom surface of the second setter is about 600 μm. In some instances, the first setter has a top surface, the second setter has a bottom surface, and the average distance between top surface of the first setter and the bottom surface of the second setter is about 650 μm. In some instances, the first setter has a top surface, the second setter has a bottom surface, and the average distance between top surface of the first setter and the bottom surface of the second setter is about 700 μm. In some instances, the first setter has a top surface, the second setter has a bottom surface, and the average distance between top surface of the first setter and the bottom surface of the second setter is about 750 μm. In any of these embodiments, spacers are used to maintain the average distance between the top surface of the first setter and the bottom surface of the second setter. The spacers may be made of the same material as the setter.

In some examples, including any of the foregoing, the top surface of the first setter is the surface of the first setter in direct contact with the green film. In an embodiment, the bottom surface of the second setter is the surface of the second setter closest to the green film. In some of these examples, the setters are rectangular cuboids or parallelepipeds. The top and bottom surfaces of the first setter are the two surfaces of the rectangular cuboid or parallelepiped which have the largest geometric surface area. The top and bottom surfaces of the first setter are not the four side surfaces of the rectangular cuboid or parallelepiped which have the smallest geometric surface area. The top and bottom surfaces of the second setter are the two surfaces of a rectangular cuboid or parallelepiped which have the largest geometric surface area. The top and bottom surfaces of the second setter are not the four side surfaces of the rectangular cuboid or parallelepiped which have the smallest geometric surface area.

In some examples, including any of the foregoing, a layer comprising metal powder is placed between the green film and the bottom setter. In some instances, the layer comprising metal powder is placed between the green film and the top setter. In some instances, a layer comprising metal powder is placed between the green film and the bottom setter. In some instances, a layer comprising metal powder is placed between the green film and the top setter. In any of these preceding examples, the process further comprises providing a second green film, wherein a layer of metal powder is placed between the first green film and second green film. In some cases, the metal powder is a powder of a metal selected from the group consisting of Al, Cu, Ni, Ag, Au, Pt, Pd, and Sn. In some cases, the metal powder is a powder of Al. In some cases, the metal powder is a powder of Cu. In some cases, the metal powder is a powder of Ni. In some cases, the metal powder is a powder of Ag. In some cases, the metal powder is a powder of Au. In some cases, the metal powder is a powder of Pt. In some cases, the metal powder is a powder of Pd. In some cases, the metal powder is a powder of Sn.

In some examples, including any of the foregoing, the green films are sintered between setter plates wherein a layer comprising metal powder is positioned between the setter plate and the green film. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr) setter, zirconia setter plates, porous zirconia setter plates, lithium oxide setter plates, porous lithium oxide setter plates, lanthanum oxide setter plates, lithium zirconium oxide (Li₂ZrO₃) setter plates, lithium aluminum oxide (LiAlO₂) setter plates, porous lanthanum oxide setter plates, Lithium zirconium oxide (Li₂ZrO₃) setter plates, lithium aluminum oxide (LiAlO₂) setter plates, garnet setter plates, porous garnet setter plates, lithium-stuffed garnet setter plates, and porous lithium-stuffed garnet setter plates, and combinations of the aforementioned.

In some examples, including any of the foregoing, the setter plates comprise one or more of the following metals or compositions: platinum, palladium, gold, copper, nickel, aluminum, alumina, porous alumina, steel, zirconium, zirconia, porous zirconia, lithium oxide, porous lithium oxide, lanthanum oxide, lithium zirconium oxide, lithium aluminum oxide, porous lanthanum oxide, lithium aluminum oxide, lithium aluminum oxide, garnet, porous garnet, lithium-stuffed garnet, and porous lithium-stuffed garnet. In certain examples, a setter plate comprises one or more of the following compositions: copper, nickel, aluminum, alumina, steel, zirconium, zirconia, lithium oxide, lanthanum oxide, lithium zirconium oxide, lithium aluminum oxide, lithium aluminum oxide, lithium aluminum oxide, and lithium-stuffed garnet.

In some examples, including any of the foregoing, the setter plates include an oxide material with lithium concentration greater than 5 mmol/cm³. In these particular examples, the metal powder is selected from Ni powder, Cu powder, Au powder, Fe powder, or combinations thereof. The metal powder may additionally include ceramic material.

In some examples, including any of the foregoing, the green films prepared by the processes herein, and those incorporated by reference, are sintered between setter plates in which a metal powder or layer (e.g., metal foil) is positioned between the setter plate and the green film, and the metal powder or layer (e.g., metal foil) contacts the green film. In some examples, after sintering, the metal powder is adhered to the sintered film.

In some examples, including any of the foregoing, the setter plates are composed of a metal, an oxide, a nitride, or a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, nickel setter plates, aluminum (Al) setter plates, alumina setter plates, porous alumina setter plates, steel setter plates, zirconium (Zr), zirconia setter plates, porous zirconia setter plates, lithium oxide setter plates, porous lithium oxide setter plates, lanthanum oxide setter plates, porous lanthanum oxide setter plates, garnet setter plates, porous garnet setter plates, lithium-stuffed garnet setter plates, porous lithium-stuffed garnet setter plates, magnesia setter plates, porous magnesia setter plates. In some examples, the setter plates include an oxide material with lithium concentration greater than 5 mmol/cm³. In some examples, the setter plates comprise lithium-stuffed garnet powder. In some examples, the present disclosure provides a setter plate comprising a Li-stuffed garnet compound characterized by the formula LiₓLa_{y}Zr_{z}Oₜ.qAl₂O₃, wherein 4<x<10, 1<y<4, 1<z<3, 6<t<14, 0≤q≤1.

In some examples, including any of the foregoing, the metal powder is selected from Ni powder, Cu powder, Mg powder, Mn powder, Au powder, Fe powder, or combinations thereof. The metal powder may additionally include ceramic material.

During certain sintering conditions, a layer of particles (e.g., a setter sheet) or powder may be placed between the green film and the setter plates to assist with the sintering of the green film, and the layer of particles (e.g., a setter sheet) or powder is in contact with the green film. In some of these examples, the layer of particles comprises a uniform layer of particles. In some other of these examples, the layer of particles comprises a uniform layer of inert, or non-reactive with the green film, particles. In some sintering conditions, the layer of particles is provided as a sheet of particles. In some examples, the thickness of the sheet or layer or particles is about equal to the size of the particles in the sheet or layer. In other examples, the inert particles positions between the green film and the setter plate(s) is positioned between the contact surfaces of the green film and the parts of the green film which are being sintered. In some continuous sintering processes, the setter plates and, or, the particles, layers, or sheets which are placed between the setter plates and the green film, may be moved or repositioned during the sintering process so that a continuous roll of sintered film is prepared in a continuous process. In these continuous processes, the setter plates and the particles, layers, or sheets, move in conjunction with the movement of the green film so that the portion of the green film being sintering is in contact with the particles, layers, or sheets which are also in contact with the setter plates. In some instances, the layers or sheets are prepared with a particular weight to prevent tape warping and surface deterioration.

In some of the examples described herein, the layer or sheet of inert and, or, uniform particles (or powders) assists the sintering process by providing a minimal amount of friction between the green film and the setter plates so that the green film is not strained as it sinters and reduces in volume and increases in density. By reducing the friction forces, the green film can shrink with minimal stress during the sintering process. This provides for improved sintered films that do not stick to the setter plates, which do not distort during the sintering process, and which do not crack during the sintering process or thereafter.

In some processes, the green films may be sintered under atmospheric air, dry air, inert gas, nitrogen gas, or argon gas.

In some instances, for any of the preceding embodiments, step (e) comprises exposing, during the heating, the green film to an Argon:H₂ mixed atmosphere. In some instances, for any of the preceding embodiments, step (e) comprises exposing, during the heating, the green film to an Argon atmosphere. In another aspect, provided herein is a process for making a sintered lithium-stuffed garnet thin film, wherein the process includes: (a) providing a green film comprising lithium-stuffed garnet powder and a binder; (b) providing a first setter; (c) placing the green film on the first setter; (d) exposing the green film to lithium, and/or lithium oxide in a vapor phase; (e) heating the green film to at least 900° C. In some of such embodiments, the method comprises placing a second setter within 2 cm of the green film but not in contact with the green film.

In some examples, the average distance between the top surface of the bottom setter and the bottom surface of the top setter is about 10 μm-1 mm. In some examples, the first setter has a top surface, wherein the second setter has a bottom surface, and wherein the average distance between top surface of the first setter and the bottom surface of the second setter is about 15 μm-750 μm. In some examples, the first setter has a top surface, wherein the second setter has a bottom surface, and wherein the average distance between top surface of the first setter and the bottom surface of the second setter is 10 μm, 25 μm, 35 μm, 50 μm, 75 μm, 100 μm, 125 μm, 150 μm, 200 μm, 250 μm, 300 μm, 350 μm, 400 μm, 500 μm, 550 μm, 650 μm, 700 μm, or 750 μm. In some examples, the average distance between the top surface of the bottom setter and the bottom surface of the top setter is about 10 μm-500 μm, 10 μm-400 μm, 10 μm-200 μm, or 25 μm-100 μm. In some examples, the average distance between the top surface of the bottom setter and the bottom surface of the top setter is about 10 μm-200 μm.

In some examples, metal powder is placed between the green film and the first setter. In some examples, metal powder is placed between the green film and the second setter. In some examples, a layer is placed between the green film and the first setter, wherein the layer comprises metal powder. In some examples, a layer is placed between the green film and the second setter, wherein the layer comprises metal powder. In some examples, the process further comprises providing a second green film, wherein a layer of metal powder is placed between the first green film and second green film. In some examples, the metal powder is a powder of a metal selected from the group consisting of Al, Cu, Ni, Ag, Au, Pt, Pd, and Sn.

In any of the processes set forth herein, heat sintering may include heating the green film in the range from about 700° C. to about 1250° C.; or about 800° C. to about 1200° C.; or about 900° C. to about 1200° C.; or about 1000° C. to about 1200° C.; or about 1100° C. to about 1200° C. In any of the processes set forth herein, heat sintering can include heating the green film in the range from about 700° C. to about 1100° C.; or about 700° C. to about 1000° C.; or about 700° C. to about 900° C.; or about 700° C. to about 800° C. In any of the processes set forth herein, heat sintering can include heating the green film to about 700° C., about 750° C., about 850° C., about 800° C., about 900° C., about 950° C., about 1000° C., about 1050° C., about 1100° C., about 1150° C., or about 1200° C. In any of the processes set forth herein, heat sintering can include heating the green film to 700° C., 750° C., 850° C., 800° C., 900° C., 950° C., 1000° C., 1050° C., 1100° C., 1150° C., or 1200° C. In any of the processes set forth herein, heat sintering can include heating the green film to about 700° C. In any of the processes set forth herein, heat sintering can include heating the green film to about 750° C. In any of the processes set forth herein, heat sintering can include heating the green film to about 850° C. In any of the processes set forth herein, heat sintering can include heating the green film to about 900° C. In any of the processes set forth herein, heat sintering can include heating the green film to about 950° C. In any of the processes set forth herein, heat sintering can include heating the green film to about 1000° C. In any of the processes set forth herein, heat sintering can include heating the green film to about 1050° C. In any of the processes set forth herein, heat sintering can include heating the green film to about 1100° C. In any of the processes set forth herein, heat sintering can include heating the green film to about 1125° C. In any of the processes set forth herein, heat sintering can include heating the green film to about 1150° C. In any of the processes set forth herein, heat sintering can include heating the green film to about 1200° C.

In any of the processes set forth herein, the processes may include heating the green film for about 1 to about 600 minutes. In any of the processes set forth herein, the processes may include heating the green film for about 20 to about 600 minutes. In any of the processes set forth herein, the processes may include heating the green film for about 30 to about 600 minutes. In any of the processes set forth herein, the processes may include heating the green film for about 40 to about 600 minutes. In any of the processes set forth herein, the processes may include heating the green film for about 50 to about 600 minutes. In any of the processes set forth herein, the processes may include heating the green film for about 60 to about 600 minutes. In any of the processes set forth herein, the processes may include heating the green film for about 70 to about 600 minutes. In any of the processes set forth herein, the processes may include heating the green film for about 80 to about 600 minutes. In any of the processes set forth herein, the processes may include heating the green film for about 90 to about 600 minutes. In any of the processes set forth herein, the processes may include heating the green film for about 100 to about 600 minutes. In any of the processes set forth herein, the processes may include heating the green film for about 120 to about 600 minutes. In any of the processes set forth herein, the processes may include heating the green film for about 140 to about 600 minutes. In any of the processes set forth herein, the processes may include heating the green film for about 160 to about 600 minutes. In any of the processes set forth herein, the processes may include heating the green film for about 180 to about 600 minutes. In any of the processes set forth herein, the processes may include heating the green film for about 200 to about 600 minutes. In any of the processes set forth herein, the processes may include heating the green film for about 300 to about 600 minutes. In any of the processes set forth herein, the processes may include heating the green film for about 350 to about 600 minutes. In any of the processes set forth herein, the processes may include heating the green film for about 400 to about 600 minutes. In any of the processes set forth herein, the processes may include heating the green film for about 450 to about 600 minutes. In any of the processes set forth herein, the processes may include heating the green film for about 500 to about 600 minutes. In any of the processes set forth herein, the processes may include heating the green film for about 1 to about 500 minutes. In any of the processes set forth herein, the processes may include heating the green film for about 1 to about 400 minutes. In any of the processes set forth herein, the processes may include heating the green film for about 1 to about 300 minutes. In any of the processes set forth herein, the processes may include heating the green film for about 1 to about 200 minutes. In any of the processes set forth herein, the processes may include heating the green film for about 1 to about 100 minutes. In any of the processes set forth herein, the processes may include heating the green film for about 1 to about 50 minutes.

In some examples, the sintering process may include sintering within a closed, but not sealed, furnace, oven, or heating chamber. In some of these examples, the green film is placed between setter plates, optionally with setter sheets or layers there between as well. In some instances, the gap between the green film to be sintered and the bottom surface of the top setter, is maintained throughout the sintering process. In some examples, the closed system includes Argon gas, a mixture of Argon gas and either Hydrogen gas or water, Air, purified Air, or Nitrogen. In some of these examples, the sintering plates have a higher surface area than the surface area of the green film which is sintered. In some examples, the setter plates and the sintering green film include the same type of calcined lithium-stuffed garnet material. In certain examples, a sacrificial source of lithium is placed in the vicinity of the film being sintered.

In some embodiments, sintering instruments used included 3″ laboratory tube furnace with controlled atmosphere in the partial pressure oxygen range of 1e⁻¹ to 1e⁻²⁰ atm with a custom temperature and gas flow control system.

In some examples, set forth herein, is a process for making a sintered lithium-stuffed garnet thin film, wherein the process comprises: (a) providing a green film comprising lithium-stuffed garnet powder and a binder; (b) providing a first setter and a second setter, wherein the first setter and second setter each comprise at least 5 atomic % lithium (Li) per setter; (c) placing the green film between and in contact with the first setter and the second setter; (d) losing contact between the green film and the second setter, wherein the second setter is within 2 cm of the green film but not in contact with the green film; and (e) heating the green film to at least 900° C.

In some examples, including any of the foregoing, step (d) comprises actively moving the second setter away from the green film. In some examples, step (c) comprises heating the green film to at least 900° C. In some examples, step (d) comprises heating the green film to at least 900° C. In some examples, steps (c) and (d) comprises heating the green film to at least 900° C.

In some examples, including any of the foregoing, step (c) occurs until the binder burns out from the green film.

In some examples, including any of the foregoing, step (c) occurs until the binder is removed by combustion, evaporation, or a combination thereof.

In some examples, including any of the foregoing, step (d) occurs after step (c).

In some examples, including any of the foregoing, the process occurs in the order in which the steps are recited.

In some examples, including any of the foregoing, step (e) comprises heating the first setter to at least 900° C.

In some examples, including any of the foregoing, step (e) comprises heating the second setter to at least 900° C.

In some examples, including any of the foregoing, the average distance between top surface of the bottom setter and the bottom surface of the top setter is about 10-1 mm.

In some examples, a setter may be reused. In some cases, a setter may be reused for a total of 2, 3, 4, 5, 6, 7, 8, 9, 10, or more uses. In some cases, the number of times a setter has been used has a correlation with the quality of the film that is sintered using the setter.

In some examples, including any of the foregoing, the first setter has a top surface, wherein the second setter has a bottom surface, and wherein the average distance between top surface of the first setter and the bottom surface of the second setter is about 15 μm-750 μm.

In certain examples, the green films are sintered while in contact with other components with which the post-sintered green films would be combined if used in an electrochemical device. For example, in some examples, the green films are layered or laminated to a positive electrode composition so that after sintering the green film, the sintered green film is adhered to the positive electrode. In another example, the green film is sintered while in contact with a metallic powder (e.g., nickel (Ni) powder). As the green film sinters, and the metal powder densities into a solid metal foil, the sintering green film bonds to the metal foil. This metal foil may serve as a current collector, or may be bonded to form an electrical connection with a current collector. The advantage of these sintering conditions is that more than one component of an electrochemical device can be prepared in one step, thus saving manufacturing time and resources.

### I. ADDITIONAL EMBODIMENTS

In some examples, set forth here is process for making a sintered lithium-stuffed garnet thin film, wherein the process comprises:
(a) providing a green film comprising lithium-stuffed garnet powder and a binder;
(b) providing a first setter and a second setter, wherein the first setter and second setter each comprise at least 5 atomic % lithium (Li) per setter;
(c) placing the green film on the first setter;
(d) placing the second setter within 2 cm of the green film but not in contact with the green film; and
(e) heating the green film to at least 900° C.

In some examples, including any of the foregoing, the green film has a density greater than 2 g/cm³ as measured by geometric density

In some examples, including any of the foregoing, step (b) occurs before step (a).

In some examples, including any of the foregoing, step (a) occurs before step (b).

In some examples, including any of the foregoing, the process occurs in the order in which the steps are recited.

In some examples, including any of the foregoing, prior to step (d), the second setter contacts the green film.

In some examples, including any of the foregoing, the second setter contacts the green film until the binder is removed prior to step (d).

In some examples, including any of the foregoing, the binder is removed by combustion, evaporation, or a combination thereof.

In some examples, including any of the foregoing, after step (e), the second setter contacts the green film.

In some examples, including any of the foregoing, step (e) comprises heating the first setter to at least 900° C.

In some examples, including any of the foregoing, step (e) comprises heating the second setter to at least 900° C.

In some examples, including any of the foregoing, prior to step (a), the process comprises providing a slurry comprising lithium-stuffed garnet powder and a binder.

In some examples, including any of the foregoing, steps (d) and (e) occur concurrently.

In some examples, including any of the foregoing, step (d), the second setter is substantially parallel to the first setter.

In some examples, including any of the foregoing, step (d), the second setter is parallel to the first setter.

In some examples, including any of the foregoing, the average distance between top surface of the bottom setter and the bottom surface of the top setter is about 10 μm-1 mm.

In some examples, including any of the foregoing, the first setter has a top surface, wherein the second setter has a bottom surface, and wherein the average distance between top surface of the first setter and the bottom surface of the second setter is about 15 μm-750 μm.

In some examples, including any of the foregoing, the first setter has a top surface, wherein the second setter has a bottom surface, and wherein the average distance between top surface of the first setter and the bottom surface of the second setter is 10 μm, 25 μm, 35 μm, 50 μm, 75 μm, 100 μm, 125 μm, 150 μm, 200 μm, 250 μm, 300 μm, 350 μm, 400 μm, 500 μm, 550 μm, 650 μm, 700 μm, or 750 μm.

In some examples, including any of the foregoing, the top surface of the first setter is the surface of the first setter in direct contact with the green film.

In some examples, including any of the foregoing, the bottom surface of the second setter is the surface of the second setter closest to the green film.

In some examples, including any of the foregoing, the green film has a density greater than 2.3 g/cm³ as measured by geometric density.

In some examples, including any of the foregoing, the green film has a density greater than 2.5 g/cm³ as measured by geometric density.

In some examples, including any of the foregoing, the green film has a density greater than 2.7 g/cm³ as measured by geometric density.

In some examples, including any of the foregoing, the green film has a density greater than 2.9 g/cm³ as measured by geometric density.

In some examples, including any of the foregoing, the green film has a density greater than 3.5 g/cm³ as measured by geometric density.

In some examples, including any of the foregoing, the green film has a density greater than 4.0 g/cm³ as measured by geometric density.

In some examples, including any of the foregoing, the green film has a density greater than 4.3 g/cm³ as measured by geometric density.

In some examples, including any of the foregoing, the green film has a density greater than 4.5 g/cm³ as measured by geometric density.

In some examples, including any of the foregoing, the green film has a density greater than 4.7 g/cm³ as measured by geometric density.

In some examples, including any of the foregoing, the 5 atomic % lithium characterizes the total amount of lithium present in the first setter or the second setter.

In some examples, including any of the foregoing, the 5 atomic % lithium characterizes the total amount of lithium which is ionically or covalently bonded to the material or materials constituting the first setter or the second setter.

In some examples, including any of the foregoing, the first setter or the second setter comprise, or both the first setter and the second setter comprise, at least 10 atomic % Li per setter.

In some examples, including any of the foregoing, the first setter or the second setter comprise, or both the first setter and the second setter comprise, at least 15 atomic % Li per setter.

In some examples, including any of the foregoing, the first setter or the second setter comprise, or both the first setter and the second setter comprise, at least 20 atomic % Li per setter.

In some examples, including any of the foregoing, the first setter or the second setter comprise, or both the first setter and the second setter comprise, at least 25 atomic % Li per setter.

In some examples, including any of the foregoing, the first setter or the second setter comprise, or both the first setter and the second setter comprise, at least 30 atomic % Li per setter.

In some examples, including any of the foregoing, the first setter or the second setter comprise, or both the first setter and the second setter comprise, at least 35 atomic % Li per setter.

In some examples, including any of the foregoing, the first setter or the second setter comprise, or both the first setter and the second setter comprise, at least 40 atomic % Li per setter.

In some examples, including any of the foregoing, the thickness (t) of the green film satisfies the equation 10 μm≤t≤500 μm.

In some examples, including any of the foregoing, t is about 100 μm.

In some examples, including any of the foregoing, t is about 25 μm.

In some examples, including any of the foregoing, the first setter comprises 100% w/w lithium-stuffed garnet having the empirical formula Li₇La₃Zr₂O₁₂-xAl₂O₃, wherein x is a rational number and 0≤x≤1.

In some examples, including any of the foregoing, when x is 0, the atomic % lithium is 100*( 7/24)%.

In some examples, including any of the foregoing, the lithium-stuffed garnet powder in the green film is a calcined lithium-stuffed garnet powder.

In some examples, including any of the foregoing, the lithium-stuffed garnet powder in the green film is selected from lithium-stuffed garnet oxide characterized by the formula LiᵤLaᵥZrₓO_{y}.zAl₂O₃, wherein u is a rational number from 4 to 8;

v is a rational number from 2 to 4;

x is a rational number from 1 to 3;

y is a rational number from 10 to 14; and

z is a rational number from 0.05 to 1;

wherein u, v, x, y, and z are selected so that the lithium-stuffed garnet oxide is charge neutral.

In some examples, including any of the foregoing, the lithium-stuffed garnet powder in the green film is selected from LiₓLa_{y}Zr_{z}Oₜ.qAl₂O₃, wherein 4<x<10, 2<y<4, 1<z<3, 10<t<14, and 0≤q≤1.

In some examples, including any of the foregoing, the lithium-stuffed garnet powder in the green film is selected from Li₇Li₃Zr₂O₁₂.Al₂O₃ and Li₇La₃Zr₂O₁₂.0.35Al₂O₃.

In some examples, including any of the foregoing, the lithium-stuffed garnet powder in the green film is doped with Nb, Ga, and/or Ta.

In some examples, including any of the foregoing, a layer of metal powder is placed between the green film and the first setter.

In some examples, including any of the foregoing, a layer of metal powder is placed between the green film and the second setter.

In some examples, including any of the foregoing, the process comprises providing a second green film, wherein a layer of metal powder is placed between the first green film and second green film.

In some examples, including any of the foregoing, the metal powder is a powder of a metal selected from the group consisting of Al, Cu, Ni, Ag, Au, Pt, Pd, Sn, alloys thereof, and combinations thereof.

In some examples, including any of the foregoing, the first setter or the second setter has, or both the first and the second setter have, a surface roughness from 1.0 μm Rₐ to 4 μm Rₐ, wherein Rₐ is an arithmetic average of absolute values of sampled surface roughness amplitudes.

In some examples, including any of the foregoing, the first setter or the second setter has, or both the first and the second setter have, a surface roughness from 0.5 μm Rₜ to 30 μm Rₜ, wherein Rₜ is the maximum peak height of sampled surface roughness amplitudes.

In some examples, including any of the foregoing, the first setter or the second setter has, or both the first and the second setter have, a surface roughness from 1.6 μm Rₐ to 2.2 μm Rₐ.

In some examples, including any of the foregoing, the first setter or the second setter has, or both the first and the second setter have, a surface roughness 3.2 μm Rₐ to 3.7 μm Rₐ.

In some examples, including any of the foregoing, the first setter or the second setter has, or both the first and the second setter have, a surface roughness 1 μm Rₜ to 28 μm Rₜ.

In some examples, including any of the foregoing, the first setter or the second setter has, or both the first and the second setter have, a surface roughness 10 μm Rₜ to 30 μm Rₜ.

In some examples, including any of the foregoing, the first setter or the second setter has, or both the first and the second setter have, a surface roughness 15 μm Rₜ to 30 μm Rₜ.

In some examples, including any of the foregoing, the green film has a surface defined by a first lateral dimension from 1 cm to 50 cm and a second lateral dimension from 0.001 cm to 50 cm.

In some examples, including any of the foregoing, the green film has a surface defined by a first lateral dimension from 1 cm to 20 cm and a second lateral dimension from 1 cm to 20 cm.

In some examples, including any of the foregoing, the geometric surface area of the green film is from about 9 cm² to about 225 cm².

In some examples, including any of the foregoing, step (e) comprises exposing, during the heating, the green film to an argon:H₂ mixed atmosphere.

In some examples, including any of the foregoing, step (e) comprises exposing, during the heating, the green film to an argon atmosphere.

In some examples, including any of the foregoing, the slurry comprises a solvent.

In some examples, including any of the foregoing, the solvent is selected from the group consisting of: toluene, xylene, ethyl acetate, tetrahydrofuran, dioxane, 1,2-dimethoxyethane, and combinations thereof.

In some examples, including any of the foregoing, the binder is a polymer is selected from the group consisting of polyacrylonitrile (PAN), polypropylene, polyethylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy ethyl glycidyl ether (PEO-MEEGE), polyethylene oxide 2-methoxyethoxy ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), and polyethyl acrylate (PEA).

In some examples, including any of the foregoing, the first setter has a surface defined by a first lateral dimension from 1 cm to 100 cm and a second lateral dimension from 0.001 cm to 100 cm.

In some examples, including any of the foregoing, the second setter has a surface defined by a first lateral dimension from 1 cm to 100 cm and a second lateral dimension from 0.001 cm to 100 cm.

In some examples, including any of the foregoing, the first setter has a surface defined by a first lateral dimension from 2 cm to 50 cm and a second lateral dimension from 2 cm to 50 cm.

In some examples, including any of the foregoing, the second setter has a surface defined by a first lateral dimension from 2 cm to 50 cm and a second lateral dimension from 2 cm to 50 cm.

In some examples, including any of the foregoing, the first setter or second setter has, or both the first and second setter have, a thickness from 0.1 mm to 100 mm.

In some examples, including any of the foregoing, the process maintains the flatness of the green film.

In some examples, including any of the foregoing, the process produces a sintered lithium-stuffed garnet solid electrolyte thin film that is less than 100 μm thick and more than 1 nm thick.

In some examples, including any of the foregoing, the process produces a sintered lithium-stuffed garnet solid electrolyte thin film that has a bulk ASR from between 0.1 Ω·cm² to 10 Ω·cm² at 50° C.

In some examples, including any of the foregoing, each setter has a first and a second dimension that is about 10%-50% larger than the first and second dimension of the green film.

In some examples, including any of the foregoing, the sintered film has a surface area that is 30% greater than the surface area of the green film.

In some examples, including any of the foregoing, set forth herein is a process for making a sintered lithium-stuffed garnet thin film, wherein the process comprises:
(a) providing a green film comprising lithium-stuffed garnet powder and a binder;
(b) providing a first setter and a second setter, wherein the first setter and second setter each comprise at least 5 atomic % lithium (Li) per setter;
(c) placing the green film between and in contact with the first setter and the second setter;
(d) losing contact between the green film and the second setter, wherein the second setter is within 2 cm of the green film but not in contact with the green film; and
(e) heating the green film to at least 900° C.

In some examples, including any of the foregoing, step (d) comprises actively moving the second setter away from the green film.

In some examples, including any of the foregoing, step (c) occurs until the binder burns out from the green film.

In some examples, including any of the foregoing, step (c) occurs until the binder is removed by combustion, evaporation, or a combination thereof.

In some examples, including any of the foregoing, step (d) occurs after step (c).

In some examples, including any of the foregoing, the process occurs in the order in which the steps are recited.

In some examples, including any of the foregoing, set forth herein is a sintered lithium-stuffed garnet thin film made by any one of the processes set forth herein.

In some examples, including any of the foregoing, the sintered lithium-stuffed garnet thin has a surface flatness of less than 500, 450, 400, 350, 300, 250, 200, 150, 100, 50, 40, 30, 20 or 10 μm.

In some examples, including any of the foregoing, the sintered lithium-stuffed garnet thin has a surface flatness that is measured as the difference between the highest point on the top surface of the film to the lowest point on the top surface of the film, on the side of the film that was closest to the second setter during the sintering step.

In some examples, including any of the foregoing, the sintered lithium-stuffed garnet thin has surface flatness that is measured on the side of the film that was in direct contact with the first setter during the sintering step.

In some examples, including any of the foregoing, the sintered lithium-stuffed garnet thin film comprises less than 1% v/v LiAlO₃.

In some examples, including any of the foregoing, set forth herein is an electrochemical cell or rechargeable battery comprising the sintered lithium-stuffed garnet thin film set forth herein.

In some examples, including any of the foregoing, set forth herein is a process for making a sintered lithium-stuffed garnet thin film, wherein the process comprises:

(a) providing a green film comprising lithium-stuffed garnet powder and a binder;

(b) providing a first setter;

(c) placing the green film on the first setter;

(d) exposing the green film to lithium and/or lithium oxide in a vapor phase;

(e) heating the green film to at least 900° C.

In some examples, including any of the foregoing, the green film has a density of greater than 2 g/cm³ as measured by geometric density.

In some examples, including any of the foregoing, the process comprises placing a second setter within 2 cm of the green film but not in contact with the green film.

In some examples, including any of the foregoing, the lithium and/or lithium oxide in a vapor phase is provided by the first setter, or by a second setter that is placed within 2 cm of the green film but not in contact with the green film, or by both.

In some examples, including any of the foregoing, the second setter is placed substantially parallel to the first setter.

In some examples, including any of the foregoing, the first setter or the second setter, or both, comprise at least 5 atomic % lithium (Li) per setter.

In some examples, including any of the foregoing, prior to step (a), the process comprises providing a slurry comprising lithium-stuffed garnet powder and a binder.

In some examples, including any of the foregoing, steps occur in the order in which they are recited.

In some examples, including any of the foregoing, steps (d) and (e) occur concurrently.

In some examples, including any of the foregoing, the first setter has a top surface, wherein the second setter has a bottom surface, and wherein the average distance between top surface of the first setter and the bottom surface of the second setter is about 15 μm-750 μm.

In some examples, including any of the foregoing, the first setter has a top surface, wherein the second setter has a bottom surface, and wherein the average distance between top surface of the first setter and the bottom surface of the second setter is 10 μm, 25 μm, 35 μm, 50 μm, 75 μm, 100 μm, 125 μm, 150 μm, 200 μm, 250 μm, 300 μm, 350 μm, 400 μm, 500 μm, 550 μm, 650 μm, 700 μm, or 750 μm.

In some examples, including any of the foregoing, the 5 atomic % lithium characterizes the total amount of lithium present in the first setter or the second setter.

In some examples, including any of the foregoing, the 5 atomic % lithium characterizes the total amount of lithium which is ionically or covalently bonded to the material or materials constituting the first setter or the second setter.

In some examples, including any of the foregoing, the thickness (t) of the green film satisfies the equation 10 μm≤t≤500 μm.

In some examples, including any of the foregoing, the green film is a multilayer of at least two laminated green films.

In some examples, including any of the foregoing, t is about 100 μm.

In some examples, including any of the foregoing, t is about 25 μm.

In some examples, including any of the foregoing, the first setter comprises 100% w/w lithium-stuffed garnet having the empirical formula Li₇La₃Zr₂O₁₂-xAl₂O₃, wherein x is a rational number and 0≤x≤1.

In some examples, including any of the foregoing, the first setter comprises 1% w/w lithium-stuffed garnet having the empirical formula Li₇La₃Zr₂O₁₂-xAl₂O₃, wherein x is a rational number and 0≤x≤1.

In some examples, including any of the foregoing, when x is 0, the atomic % lithium is 100*( 7/24)%.

In some examples, including any of the foregoing, the lithium-stuffed garnet powder in the green film is a calcined lithium-stuffed garnet powder.

In some examples, including any of the foregoing, the lithium-stuffed garnet powder in the green film is selected from lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

In some examples, including any of the foregoing, the lithium-stuffed garnet powder in the green film is selected from LiₓLa_{y}Zr_{z}Oₜ.qAl₂O₃, wherein 4<x<10, 2<y<4, 1<z<3, 10<t<14, and 0≤q≤1.

In some examples, including any of the foregoing, the lithium-stuffed garnet powder in the green film is selected from Li₇Li₃Zr₂O₁₂.Al₂O₃ and Li₇La₃Zr₂O₁₂.0.35Al₂O₃.

In some examples, including any of the foregoing, the lithium-stuffed garnet powder in the green film is doped with Nb, Ga, and/or Ta.

In some examples, including any of the foregoing, a layer of metal powder is placed between the green film and the first setter.

In some examples, including any of the foregoing, a layer of metal powder is placed between the green film and the second setter.

In some examples, including any of the foregoing, the process comprises providing a second green film, wherein a layer of metal powder is placed between the first green film and second green film.

In some examples, including any of the foregoing, the metal powder is a powder of a metal selected from the group consisting of Al, Cu, Ni, Ag, Au, Pt, Pd, and Sn.

In some examples, including any of the foregoing, the slurry comprises a solvent.

In some examples, including any of the foregoing, the solvent is selected from the group consisting of: toluene, xylene, ethyl acetate, tetrahydrofuran, dioxane, and 1,2-dimethoxyethane.

In some examples, including any of the foregoing, the binder is a polymer is selected from the group consisting of polyacrylonitrile (PAN), polypropylene, polyethylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide (2-methoxyethoxy)ethyl glycidyl ether (PEO-MEEGE), polyethylene oxide (2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), and polyethyl acrylate (PEA).

In some examples, including any of the foregoing, the process maintains the flatness of the green film.

In some examples, including any of the foregoing, the process produces a sintered lithium-stuffed garnet solid electrolyte less than 100 microns thick and more than 1 nm thick.

In some examples, including any of the foregoing, the process produces a sintered lithium-stuffed garnet solid electrolyte that has an ASR from between 0.1 Ω·cm² to 10 Ω·cm² at 50° C.

In some examples, including any of the foregoing, the sintered film has a surface area that is 30% less than the surface area of the green film.

In some examples, including any of the foregoing, the first setter has a surface roughness from 1.0 μm Rₐ to 4 μm Rₐ, wherein Rₐ is an arithmetic average of absolute values of sampled surface roughness amplitudes.

In some examples, including any of the foregoing, the first setter has a surface roughness from 0.5 μm Rₜ to 30 μm Rₜ, wherein Rₜ is the maximum peak height of sampled surface roughness amplitudes.

In some examples, including any of the foregoing, set forth herein is a sintered lithium-stuffed garnet thin film made by any one of the processes set forth herein.

In some examples, including any of the foregoing, the sintered lithium-stuffed garnet thin has a surface flatness of less than 500, 450, 400, 350, 300, 250, 200, 150, 100, 50, 40, 30, 20 or 10 μm.

In some examples, including any of the foregoing, the surface flatness is measured as the difference between the highest point on the top surface of the film to the lowest point on the top surface of the film, on the side of the film that was closest to the second setter during the sintering step.

In some examples, including any of the foregoing, the surface flatness is measured on the side of the film that was in direct contact with the first setter during the sintering step.

In some examples, including any of the foregoing, the sintered lithium-stuffed garnet thin film comprises less than 1% v/v secondary phases.

In some examples, including any of the foregoing, set forth herein is an electrochemical cell or rechargeable battery comprising the sintered lithium-stuffed garnet thin film of any process set forth herein.

In some examples, including any of the foregoing, set forth herein is an apparatus comprising a bottom setter; a top setter; and a green film between the bottom setter and the top setter; wherein the green film contacts the bottom setter but does not contact the top setter.

In some examples, including any of the foregoing, the distance between the green film and the top setter is at least 2 μm.

In some examples, including any of the foregoing, the distance between the bottom setter and the top setter is at least 2 cm.

In some examples, including any of the foregoing, the distance between the bottom setter and the top setter is no greater than 100 cm.

In some examples, including any of the foregoing, the distance between the bottom setter and the top setter is no greater than 1 m.

In some examples, including any of the foregoing, spacers are positioned between the bottom setter and the top setter.

In some examples, including any of the foregoing, the spacers are equally spaced from each other.

In some examples, including any of the foregoing, the bottom setter is square shaped and the spacers are placed at the corners of the bottom setter.

In some examples, including any of the foregoing, the bottom setter is rectangular shaped and the spacers are placed at the corners of the bottom setter.

In some examples, including any of the foregoing, the processes herein comprise using the first setter or second setter, or both, in at least two sintering processes.

In some examples, including any of the foregoing, the processes herein comprise using the first setter or second setter, or both, in at least five sintering processes.

### J. EXAMPLES

### Analytical Tools

In some embodiments, SEM Electron microscopy was performed in a Helios 600i or FEI Quanta for measurement. In some embodiments, surface roughness was measured by an optical microscope such as the Keyence VR that may measure height and calculate a roughness value. In some embodiments, powder density was measured using a pycnometer. In some embodiments, green film density was measured using geometric process or by using Archimedes process. In some embodiments, variance in green film thickness was measured using beta-gauge, micrometer, or cross-section images. Flatness is measured by a Keyence VR microscope that measures film height. The flatness is defined as the maximum vertical distance between the lowest point on the film top surface to the highest point on the film top surface.

### Example 1—Process for Making a High Density Green Film

A slurry of calcined lithium stuffed garnet was prepared by mixing 80 g of calcined lithium stuffed garnet with of 50 ml a 33% w/w solution of polyvinyl butyral in toluene and 4 g of plasticizer di-butyl Phthalate. A polyacrylic binder was included at 3 weight percent of the solution. The slurry was tape casted onto a silicone coated substrate using a doctor blade (blade height is set to 300 μm) and had a dried tape thickness of around 100 μm. The cast mixed slurry was allowed to dry in a dry room at room temperature for 2-6 hours to form a green film. The weight loading of calcined lithium stuffed garnet was 8.4 percent by weight. The density of the green film was 2.75 g/cm³.

### Example 2—Sintering a Green Film

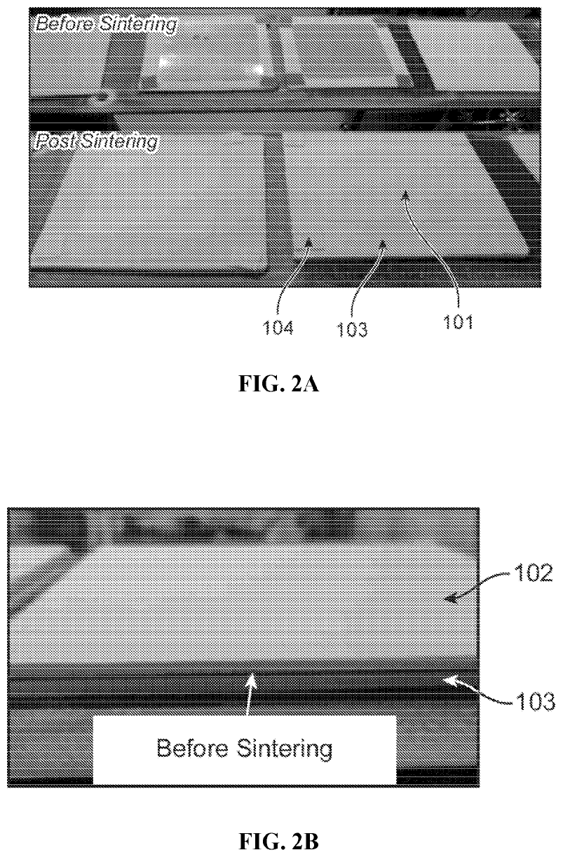

In this example, a green film was prepared as set forth in Example 1. The green film was placed on a bottom setter plate, and spacers were placed by hand at each of the four corners of the bottom setter plate to introduce a gap between the film and the bottom surface of a top setter plate (FIG. 2B). The spacers are labeled 104 in FIG. 2A. One set of green films were sintered at 975-1125° C. for 1-8 hours. Prior to the sintering, de-bindering was performed in Ar gas at 600° C. During sintering the atmosphere around the sintering green film had a pO₂ in the range 0.5-10⁻²⁰ atm

FIG. 2A shows results from a sintering experiment illustrating the change in dimensions of the film after sintering using the methods described herein. The results show a high quality sintered film.

### Example 3—Electrochemical Performance of Sintered Thin Films

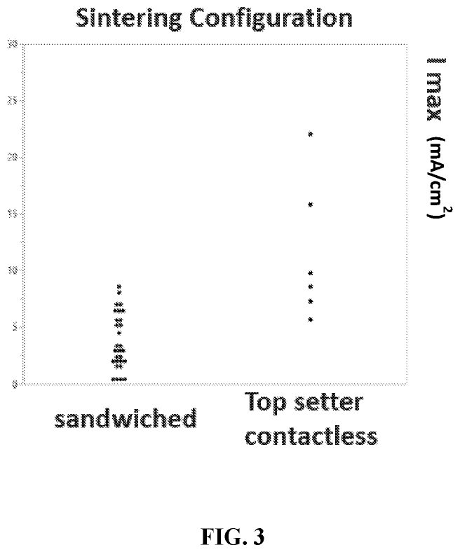

FIG. 3 shows the electrochemical performance of lithium-stuffed garnet films sintered by the methods described herein.

The sintered lithium-stuffed garnet films were placed in symmetric cells with lithium metal evaporated on opposing sides of the sintered lithium-stuffed garnet films. A lithium-ion current was passed between the sintered lithium-stuffed garnet films and the current density was increased until the cell failed due to electrical shorting. The test included pulses of 0.5 μm of lithium metal at 45° C. and in a pressurized cell that was pressurized to 300-600 pounds-per-square-inch (PSI). The maximum current density before failure was noted for each film.

FIG. 3 shows that sintered lithium-stuffed garnet films prepared using a 200 gap between the bottom setter and the top setter sustained higher current densities before failure compared to sintered lithium-stuffed garnet films prepared by sintering the films between and in direct contact with the top setter and the bottom setter.

### Example 4—Electrochemical Performance of Sintered Thin Films

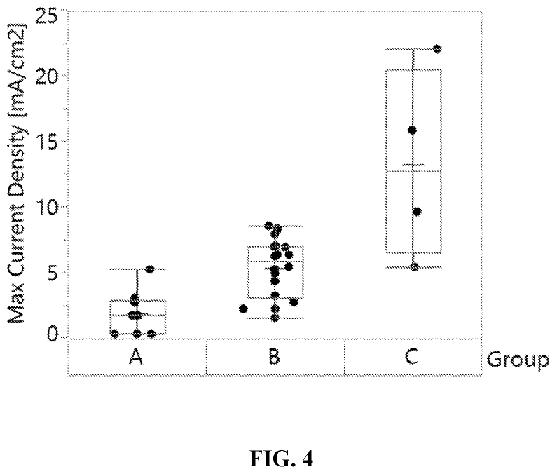

FIG. 4 shows that sintered lithium-stuffed garnet films prepared using a gap between the bottom setter and the top setter sustained higher current densities before failure due to lithium dendrite formation compared to sintered lithium-stuffed garnet films prepared by sintering the films between and in direct contact with the top setter and the bottom setter.

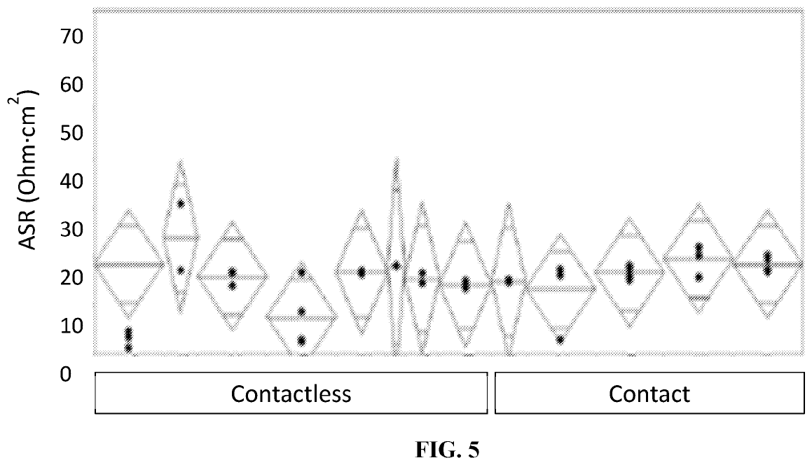

In another test, sintered lithium-stuffed garnet films were placed in symmetric Li-garnet-Li cells and in which 0.4 mA/cm² lithium-ion current density was conducted through the sintered lithium-stuffed garnet thin film, in 5 μm pulses and at 45° C. and 600 PSI. As shown in FIG. 5, the sintered lithium-stuffed garnet films prepared with gap between the bottom setter and the top setter had, on average, similar area-specific resistance (ASR) when compared to sintered lithium-stuffed garnet films prepared by sintering the films between and in direct contact with the top setter and the bottom setter.

The sintered lithium-stuffed garnet films were placed in symmetric cells with lithium metal evaporated on opposing sides of the sintered lithium-stuffed garnet films. A lithium-ion current was passed between the sintered lithium-stuffed garnet films and the current density was increased until the cell failed due to electrical shorting. The test included pulses of 0.5 μm of lithium metal at 45° C. and in a pressurized cell that was pressurized to 600 pounds-per-square-inch (PSI). In FIG. 4, Group A represents sintered lithium-stuffed garnet films prepared by sintering between and in direct contact with setter plates, wherein the films have flaws or defects. In FIG. 4, Group B represents sintered lithium-stuffed garnet films prepared by sintering between and in direct contact with setter plates, wherein the films do not have flaws or defects. Group C represents sintered lithium-stuffed garnet films prepared using a 200 μm gap between the bottom setter and the top setter. FIG. 4 shows that sintered lithium-stuffed garnet films prepared using a gap between the bottom setter and the top setter (i.e. Group C) sustained higher current densities before failure (between 5-20 mA/cm²) compared to sintered lithium-stuffed garnet films prepared by sintering the films between and in direct contact with the top setter and the bottom setter (i.e. Group A and Group B), wherein the max current densities ranged from 0 to 8 mA/cm².

### Example 5—Making a Setter

Ceramic powders of lithium-stuffed garnet were ballmilled until the d₅₀ of the garnet powder was between 0.5-5 μm. After removing the milling media and drying, the powder was pressed in a pellet press with diameter 19 mm under about 3 metric tons to form a pressed pellet. The pressed pellet was sintered at 1000-1200° C. for 4-8 hours to form a sintered setter.

### Example 6—Sintering with Variable Setter Gap Settings

In this example, a lithium-stuffed garnet green film was prepared in methods analogous to Example 1 to a thickness of 75 μm.

Top and bottom setter plates comprising lithium-stuffed garnet was used.

The lithium-stuffed garnet green film was placed on top of the bottom setter plate. Spacers were placed by hand at each of the four corners of the bottom setter plate to introduce a space between the film and the bottom surface of the top setter plate. The green films were sintered at above 1000° C. in an inert gas atmosphere.

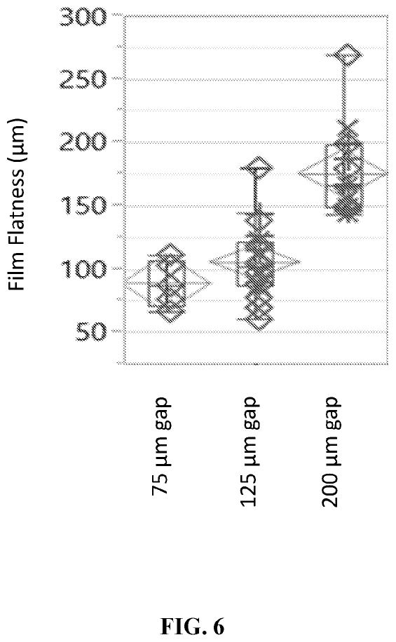

In one series of experiments, the gap between the top surface of the bottom setter and the bottom surface of the top setter was 75 μm. In another series of experiments, the gap between the top surface of the bottom setter and the bottom surface of the top setter was 125 μm. In another series of experiments, the gap between the top surface of the bottom setter and the bottom surface of the top setter was 200 μm. The resulting film flatness is shown in FIG. 6. As shown in FIG. 6, the average film flatness of films sintered with a 75 μm gap between setters was about 75 μm, the average film flatness of films sintered with a 125 μm gap between setters was about 100 μm, and the average film flatness of films sintered with a 200 μm gap between setters was about 175 μm.

### Example 7—Contact Sintering and Contactless Sintering

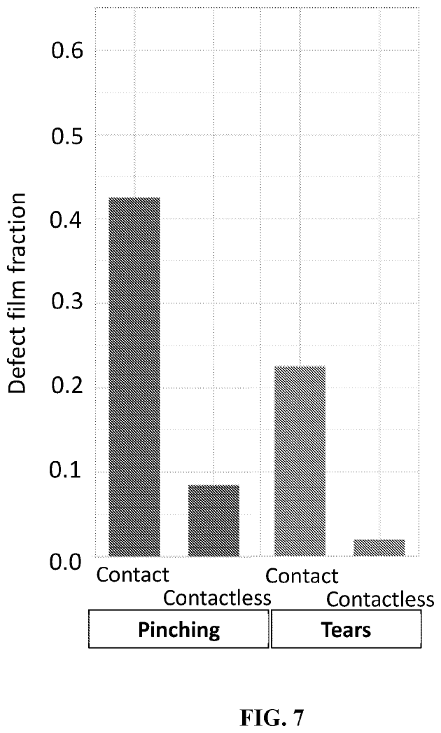

In this example, lithium-stuffed garnet films were sintered using one of two methods: contact and contactless sintering. Contact sintering meant that the top and bottom setters both contacted the sintering green film. Contactless sintering meant that the top setter did not contact the sintering green film. The lithium-stuffed garnet green films had a thickness of 25 μm with width and length dimensions of 36 μm by 36 μm. The gap for the contactless sintering (i.e., the distance between the top surface of the bottom setter and the bottom surface of the top setter) was 125 μm. As shown in FIG. 7, the fraction of films with pinching or tearing decreased significantly when the films were sintering using contactless sintering in comparison to contact sintering. The percentage of films with pinching decreased from about 40% to about 10% when comparing contact sintering to contactless sintering. The percentage of films with tears decreased from about 20% to about 2% when comparing contact sintering to contactless sintering.

### Example 8—Contactless Sintering

In this example, a lithium-stuffed garnet green film was prepared as in Example 1 but to a thickness of 25 μm with width and length dimensions of 36 μm by 36 μm.

Top and bottom setter plates comprising lithium-stuffed garnet was used. The lithium-stuffed garnet green film was placed on top of the bottom setter plate. Spacers were placed by hand at each of the four corners of the bottom setter plate to introduce a gap between the film and the bottom surface of the top setter plate. The green films were sintered at above 1000° C. in an inert gas atmosphere.

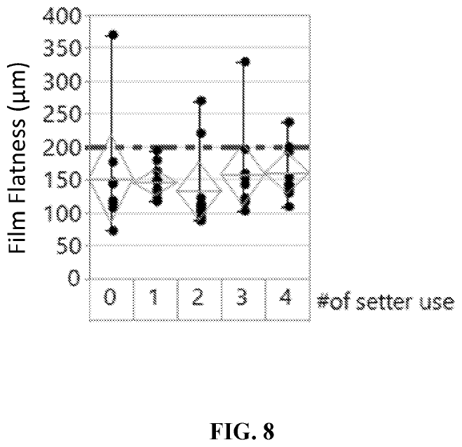

The gap between the top surface of the bottom setter and the bottom surface of the top setter was 125 μm. FIG. 8 shows the average film flatness based on the number of times a setter was used. As seen in FIG. 8, the average film flatness over the first 5 uses of a setter stayed fairly consistent, wherein the average film flatness was around 150 μm.

### Example 9—Contact Sintering

In this example, a lithium-stuffed garnet green film was prepared as in Example 1 to a thickness of 25 μm with width and length dimensions of 36 μm by 36 μm. Top and bottom setter plates comprising lithium-stuffed garnet was used. The lithium-stuffed garnet green film was placed on top of the bottom setter plate. The top setter was then placed directly onto the film. The green films were sintered at above 1000° C. in an inert gas atmosphere.

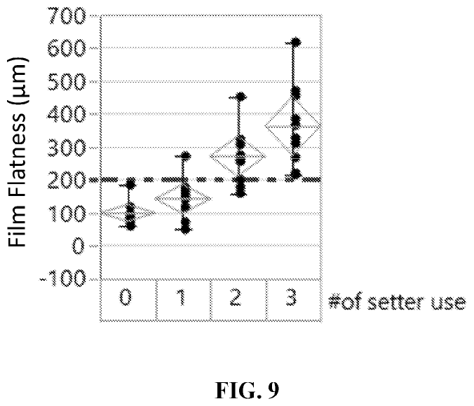

FIG. 9 shows the average film flatness based on the number of times a setter was used. As seen in FIG. 9, the average film flatness over the first 4 uses of a setter increased with each use, as the average film flatness was at around 100 μm on the first use, around 150 μm on the second use, around 275 μm on the third use, and around 350 μm on the fourth use.

The foregoing description of the embodiments of the disclosure has been presented for the purpose of illustration; it is not intended to be exhaustive or to limit the claims to the precise forms disclosed. Persons skilled in the relevant art can appreciate that using no more than routine experimentation, numerous equivalents, modifications and variations are possible in light of the above disclosure.

What is claimed is:

1. A process for making a sintered lithium-stuffed garnet thin film, comprising:
(a) providing a green film comprising lithium-stuffed garnet powder;
(b) providing a first setter and a second setter, wherein the first setter and second setter each comprise at least 5 atomic % lithium (Li) per setter;
(c) placing the green film on the first setter;
(d) placing the second setter within 2 cm of the green film but not in contact with the green film; and
(e) heating the green film to at least 900° C.

2. The process of claim 1, wherein the green film comprises a binder.

3. The process of claim 1-2, wherein the green film has a density greater than 2 g/cm³ as measured by geometric density

4. The process of any one of claims 1-3, wherein prior to step (a), the process comprises providing a slurry comprising lithium-stuffed garnet powder and a binder.

5. The process of any one of claims 1-4, wherein in step (d), the second setter is substantially parallel to the first setter.

6. The process of any one of claims 1-5, wherein the average distance between top surface of the bottom setter and the bottom surface of the top setter is about 10 μm-1 mm.

7. The process of claim 6, wherein the top surface of the first setter is the surface of the first setter in direct contact with the green film.

8. The process of any one of claims 1-7, wherein the first setter or the second setter comprise, or both the first setter and the second setter comprise, at least 5 atomic % Li per setter.

9. The process of any one of claims 1-8, wherein the thickness of the green film is 10 μm to 500 μm.

10. The process of any one of claims 1-9, wherein the lithium-stuffed garnet powder in the green film is selected from lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

11. The process of any one of claims 1-9, wherein the lithium-stuffed garnet powder in the green film is selected from LiₓLa_{y}Zr_{z}Oₜ.qAl₂O₃, wherein 4<x<10, 2<y<4, 1<z<3, 10<t<14, and 0≤q≤1.

12. The process of any one of claims 1-11, wherein the lithium-stuffed garnet powder in the green film is doped with a member selected from the group consisting of Nb, Ga, Ta, and combinations thereof.

13. The process of any one of claims 1-12, wherein a layer is placed between the green film and the second setter, wherein the layer comprises a metal powder.

14. The process of any one of claims 1-13, wherein the first setter or second setter comprises lithium-stuffed garnet powder.

15. The process of any one of claims 1-13, wherein the first setter or the second setter has, or both the first and the second setter have, a surface roughness from 1.0 μm Rₐ to 4 μm Rₐ, wherein Rₐ is an arithmetic average of absolute values of sampled surface roughness amplitudes.

16. The process of any one of claims 1-14, wherein the green film has a surface defined by a first lateral dimension from 1 cm to 50 cm and a second lateral dimension from 0.001 cm to 50 cm.

17. The process of any one of claims 1-15, wherein the slurry comprises a solvent.

18. The process of any one of claims 1-16, comprising placing the second setter within 2 μm of the green film but not in contact with the green film.

19. The process of any one of claims 1-17, wherein the first setter has a surface defined by a first lateral dimension from 1 cm to 100 cm and a second lateral dimension from 0.001 cm to 100 cm.

20. The process of any one of claims 1-19, comprising using the first setter or second setter, or both, in at least two sintering processes.

21. The process of any one of claims 1-19, comprising using the first setter or second setter, or both, in at least five sintering processes.

22. A process for making a sintered lithium-stuffed garnet thin film, wherein the method comprises:
(a) providing a green film comprising lithium-stuffed garnet powder and a binder;
(b) providing a first setter and a second setter, wherein the first setter and second setter each comprise at least 5 atomic % lithium (Li) per setter;
(c) placing the green film between and in contact with the first setter and the second setter;
(d) losing contact between the green film and the second setter, wherein the second setter is within 2 cm of the green film but not in contact with the green film; and
(e) heating the green film to at least 900° C.

23. The process of claim 22, wherein step (c) occurs until the binder is removed by combustion, evaporation, or a combination thereof.

24. A sintered lithium-stuffed garnet thin film made by any one of the methods in claims 1-23.

25. The sintered lithium-stuffed garnet thin film of claim 24, having a surface flatness of less than 500, 450, 400, 350, 300, 250, 200, 150, 100, 50, 40, 30, 20 or 10 μm.

26. An electrochemical cell or rechargeable battery comprising the sintered lithium-stuffed garnet thin film of claim 24 or 25.

27. A sintered lithium-stuffed garnet thin film made by any one of the processes in claims 1-23.

28. An electrochemical cell or rechargeable battery comprising the sintered lithium-stuffed garnet thin film of any one of claim 24, 25, or 27.

29. An apparatus comprising
a bottom setter;
a top setter; and
a green film between the bottom setter and the top setter;
wherein the green film contacts the bottom setter but does not contact the top setter.

30. The apparatus of claim 29, wherein the distance between the green film and the top setter is at least 2 μm.

31. The apparatus of claim 29, wherein the distance between the bottom setter and the top setter is at least 2 cm.

32. The apparatus of claim 30 or 31, wherein the distance between the bottom setter and the top setter is no greater than 100 cm.

33. The apparatus of any one of claims 29-32, comprising spacers between the bottom setter and the top setter.

34. The apparatus of claim 33, wherein each spacers is equally spaced from each other spacer.

35. The apparatus of claim 33 or 34, wherein the bottom setter is square shaped and the spacers are placed at the corners of the bottom setter.

36. The apparatus of claim 33 or 34, wherein the bottom setter is rectangular shaped and the spacers are placed at the corners of the bottom setter.
